(19) United States
(12) Patent Application Publication
(10) Pub. No.: US 2018/0244386 A1
(43) Pub. Date: Aug. 30, 2018

(54) WEATHER SENSING

(71) Applicant: Top Flight Technologies, Inc., Malden, MA (US)

(72) Inventor: Long N. Phan, Winchester, MA (US)

(21) Appl. No.: 15/893,992

(22) Filed: Feb. 12, 2018

Related U.S. Application Data
(60) Provisional application No. 62/458,171, filed on Feb. 13, 2017.

(51) Int. Cl. B64C 39/02; B64C 27/12; G08G 5/00; G01W 1/02

(52) U.S. Cl. CPC B64C 39/024; B64C 27/12; B64C 2201/165; G01W 1/02; B64C 2201/127; G08G 5/0091

(57) ABSTRACT

An unmanned aerial vehicle includes an atmospheric sensor configured to measure an atmospheric condition. The unmanned aerial vehicle includes a rotor motor configured to drive rotation of a propeller of the unmanned aerial vehicle. The unmanned aerial vehicle includes a hybrid energy generation system including a rechargeable battery configured to provide electrical energy to the rotor motor; an engine configured to generate mechanical energy; and a generator coupled to the engine and configured to generate electrical energy from the mechanical energy generated by the engine, the electrical energy generated by the generator being provided to at least one of the rechargeable battery and the rotor motor.

### CLAIM OF PRIORITY

This application claims priority U.S. Patent Application Ser. No. 62/458,171, filed on Feb. 13, 2017, the contents of which are incorporated here by reference in their entirety.

### TECHNICAL FIELD

This invention relates to a weather sensing system.

### BACKGROUND

A multi-rotor unmanned aerial vehicle (UAV) may include rotor motors, one or more propellers coupled to each rotor motor, electronic speed controllers, a flight control system (auto pilot), a remote control (RC) radio control, a frame, and a battery, such as a lithium polymer (LiPo) or similar type rechargeable battery. Multi-rotor UAVs can perform vertical take-off and landing (VTOL) and are capable of aerial controls with similar maneuverability to single rotor aerial vehicles.

### SUMMARY

In an aspect, an unmanned aerial vehicle includes an atmospheric sensor configured to measure an atmospheric condition. The unmanned aerial vehicle includes a rotor motor configured to drive rotation of a propeller of the unmanned aerial vehicle. The unmanned aerial vehicle includes a hybrid energy generation system including a rechargeable battery configured to provide electrical energy to the rotor motor; an engine configured to generate mechanical energy; and a generator coupled to the engine and configured to generate electrical energy from the mechanical energy generated by the engine, the electrical energy generated by the generator being provided to at least one of the rechargeable battery and the rotor motor.

Embodiments can include one or more of the following features.

The atmospheric sensor comprises one or more of a thermometer, a barometer, a humidity sensor, a wind sensor, and a solar radiation sensor. The atmospheric sensor comprises a sensor configured to measure an impurity in one or more of precipitation and ambient moisture. The atmospheric sensor comprises a sensor configured to measure particulates in air. The atmospheric sensor comprises a sensor configured to measure an air quality.

The unmanned aerial vehicle includes an avionics system configured to control navigation of the unmanned aerial vehicle. The avionics system is configured to control one or more of a lateral motion of the unmanned aerial vehicle and an altitude of the unmanned aerial vehicle. The avionics system is configured to control the navigation of the unmanned aerial vehicle based on the atmospheric condition measured by the atmospheric sensor. The avionics system is configured to control the navigation of the unmanned aerial vehicle based on the measured atmospheric condition satisfying a target atmospheric condition.

The unmanned aerial vehicle includes a processor configured to determine a second atmospheric condition based on a measured inertial output of the unmanned aerial vehicle. The unmanned aerial vehicle includes an inertial measurement unit configured to measure the inertial output of the unmanned aerial vehicle.

The unmanned aerial vehicle includes a flexible coupling device directly coupling a rotor of the engine to the generator. The coupling device includes a cooling device oriented to provide air flow to one or more of the engine and the generator.

In an aspect, a method includes operating a hybrid energy generation system to provide electrical energy to a rotor motor configured to drive rotation of a propeller of an unmanned aerial vehicle, including generating mechanical energy in an engine of the hybrid energy generation system, in a generator of the hybrid energy generation system, converting the mechanical energy into electrical energy, providing at least some of the electrical energy produced by the generator to a rechargeable battery of the hybrid energy generation system, and providing electrical energy to the rotor motor, the electrical energy being one or more of (i) the electrical energy produced by the generator and (ii) electrical energy from the rechargeable battery. The method includes measuring an atmospheric condition by an atmospheric sensor disposed on the unmanned aerial vehicle.

Embodiments can have one or more of the following features.

The method includes controlling a navigation of the unmanned aerial vehicle. The method includes controlling the navigation of the unmanned aerial vehicle responsive to the measured atmospheric condition. The method includes controlling one or more of an altitude, a lateral motion, and a rotation of the unmanned aerial vehicle responsive to the measured atmospheric condition. The method includes controlling the navigation of the unmanned aerial vehicle based on the measured atmospheric condition satisfying a target atmospheric condition. The method includes controlling the navigation of the unmanned aerial vehicle based on an expected atmospheric condition.

The method includes measuring an inertial output of the unmanned aerial vehicle; and determining a second atmospheric condition based on the measured inertial output. The method includes measuring the inertial output of the unmanned aerial vehicle.

Measuring an atmospheric condition comprises measuring one or more of a temperature, a pressure, a humidity, a wind characteristic, and a solar radiation characteristic. Measuring an atmospheric condition comprises measuring an impurity in one or more of precipitation and ambient moisture. Measuring an atmospheric condition comprises measuring particulates in air. Measuring an atmospheric condition comprises measuring an air quality.

The details of one or more embodiments of the subject matter described herein are set forth in the accompanying drawings and the description below. Other features, objects, and advantages of the subject matter will be apparent from the description and drawings, and from the claims.

### DESCRIPTION OF DRAWINGS

FIG. 1 shows an example of an unmanned aerial vehicle (UAV) configured for measuring atmospheric conditions.

FIG. 2 shows an example of a model used for determining changes in wind and pressure based on a vehicle dynamic model and an inertial output of the UAV.

FIGS. 3 and 4 show examples of sensor networks that include a plurality of UAVs.

FIG. 5 shows a diagram of an example micro hybrid generator system.

FIG. 6 shows a side perspective view of a micro hybrid generator system.

FIG. 7A shows a side view of a micro hybrid generator.

FIG. 7B shows an exploded side view of a micro hybrid generator.

FIG. 8 shows a perspective view of a micro hybrid generator system.

FIG. 9 shows a perspective view of a UAV integrated with a micro hybrid generator system.

FIG. 10 shows a graph comparing energy density of different UAV power sources.

FIG. 11 shows a graph of market potential vs. endurance for an example UAV with an example micro hybrid generator system.

FIG. 12 shows an example flight pattern of a UAV with a micro hybrid generator system.

FIG. 13 shows a diagram of a micro hybrid generator system with detachable subsystems.

FIG. 14A shows a diagram of a micro hybrid generator system with detachable subsystems integrated as part of a UAV.

FIG. 14B shows a diagram of a micro hybrid generator system with detachable subsystems integrated as part of a ground robot.

FIG. 15 shows a ground robot with a detachable flying pack in operation.

FIG. 16 shows a control system of a micro hybrid generator system.

FIGS. 17-19 show diagrams of a UAV.

FIGS. 20 and 21 show diagrams of portions of a micro hybrid generator system.

FIGS. 22A and 22B show diagrams of portions of a micro hybrid generator system.

FIG. 23 shows a diagram of a portion of an engine.

### DETAILED DESCRIPTION

Described herein is an unmanned aerial vehicle (UAV) that can be used for weather sensing. For example, the UAV can include one or more sensors for measuring atmospheric conditions, such as temperature, barometric pressure, humidity, wind speed, wind direction, precipitation amounts, solar radiation, visibility, cloud ceiling, moisture content (e.g., for impurities, etc.), and air content (e.g., for particulates, etc.), among others. The measurements taken by the UAV can be used for weather forecasts, to study weather, to study climate, etc.

In some implementations, the UAV itself can be used as a portable weather probe that travels in 3D space to sense atmospheric conditions at various locations. In addition to being capable of traveling to various longitudinal and latitudinal (e.g., x, y) coordinates, the UAV is able to easily adjust its altitude in order to sense atmospheric conditions at different atmospheric layers (e.g., the troposphere, stratosphere, mesosphere, etc.). In some implementations, the UAV may be instructed (e.g., manually or automatically) to move to a particular location based on one or more current or previously-obtained measurements.

In some implementations, atmospheric conditions may be measured or inferred based on the UAV's response to such atmospheric conditions. For instance, information related to flight dynamics of the UAV may be used to measure changes in barometric pressure, wind speed, and wind direction, among others. Such measurements may be obtained by considering information logged by an avionics system and flight controller of the UAV.

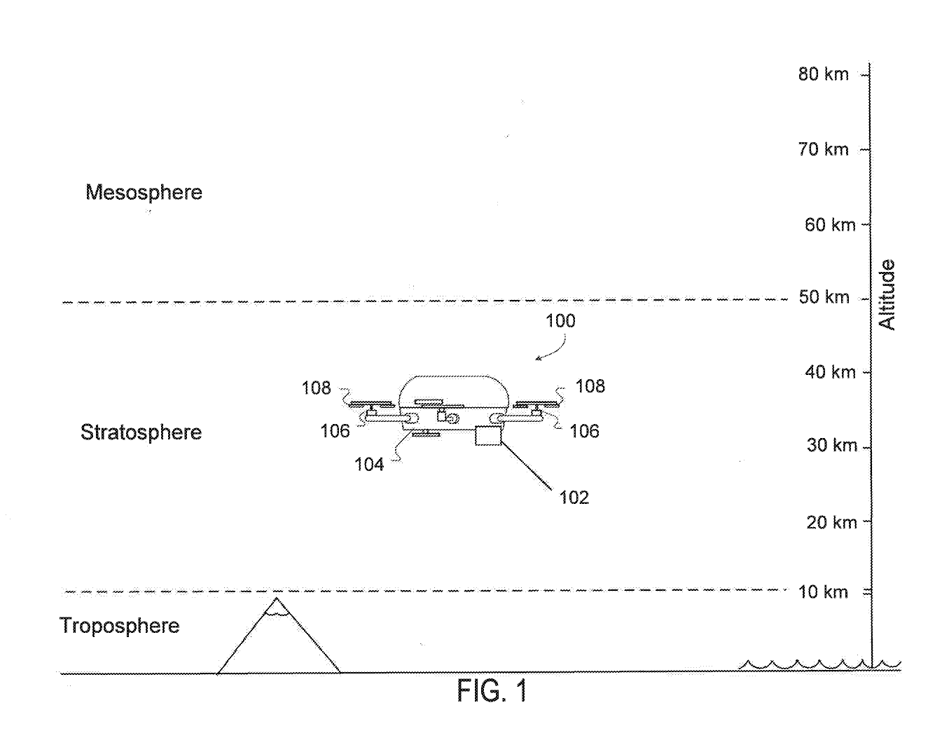

FIG. 1 shows an example of a UAV 100 configured, e.g., for measuring atmospheric conditions. The UAV 100 is depicted as being located in the stratosphere, but it should be understood that the UAV 100 can travel to other layers of the atmosphere, such as the troposphere and the mesosphere, among others. The UAV 100 includes a frame 104 to which multiple rotors 106 are coupled. Each rotor 106 is coupled to a propeller 108. In some implementations, the rotors 106 and propellers 108 are part of a micro hybrid generator system, as described in greater detail below.

The UAV 100 includes an atmospheric sensor 102 that is configured to measure one or more atmospheric conditions, such as temperature, barometric pressure, humidity, wind speed, wind direction, precipitation amounts, solar radiation, visibility, cloud ceiling, moisture content (e.g., for impurities, etc.), and air content (e.g., for particulates, etc.), among others. While the atmospheric sensor 102 is depicted as being a single package, it should be understood that in some implementations, the atmospheric sensor 102 includes a plurality of sensors each configured for measuring one or more atmospheric conditions. For example, the atmospheric sensor 102 may include a temperature sensor (e.g., a thermometer), a pressure sensor (e.g., a barometer), a humidity sensor (e.g., a hygrometer), a wind sensor (e.g., an anemometer), a solar radiation sensor (e.g., a pyranometer), a rain gauge, a disdrometer, a transmissometer, a ceilometer, etc. Similarly, while the atmospheric sensor 102 is depicted as being positioned outside of the UAV 100, in some implementations, the atmospheric sensor 102 may be positioned inside a housing of the UAV 100. In some implementations, one or more of the sensors that make up the atmospheric sensor 102 may be positioned inside of the housing of the UAV 100 and one or more of the sensors may be positioned outside of the housing of the UAV 100, e.g., depending on the design and/or function of the sensor.

In some implementations, the atmospheric sensor 102 is configured to measure impurities in moisture (e.g., precipitation, ambient moisture, etc.). For example, the atmospheric sensor 102 may be configured to measure one or more of pH, dissolved oxygen, oxidation-reduction potential, conductivity (e.g., salinity), turbidity, and dissolved ions such as Calcium, Nitrate, Fluoride, Iodine, Chloride, Cupric, Bromide, Silver, Fluoroborate, Ammonia, Lithium, Magnesium, Nitrite, Potassium, Sodium, and Perchlorate, among others.

In some implementations, the atmospheric sensor 102 is configured to measure particulates in air (e.g., ambient air). For example, the atmospheric sensor 102 may be configured to detect and/or measure suspended particulate matter, thoracic and respirable particles, inhalable coarse particles, fine particles of various dimensions, ultrafine particles, and soot, among others. In some implementations, the atmospheric sensor 102 is also configured to measure other parameters related to air quality and/or pollution, such as an amount of ozone, carbon monoxide, sulfur dioxide, and nitrous oxide, to name a few, in the ambient air.

The UAV 100 can be used as a portable weather probe that is configured to travel to various longitudinal and latitudinal locations and through various altitudes in order to measure atmospheric conditions using the atmospheric sensor 102. Unlike traditional weather probes (e.g., weather balloons, weather sensors, etc.), the UAV 100 is equipped with a flight system (described in more detail below) that permits the UAV 100 to navigate freely. For example, by way of comparison, a weather balloon or other high altitude balloon may be configured to attain a particular altitude but otherwise have no control over its direction (e.g., longitudinal and latitudinal direction) of travel. Once the weather balloon is released into the atmosphere, it may be unable to adjust its altitude until and unless it is landed and reconfigured. In contrast, the UAV 100 can actively adjust its direction of travel—both in latitudinal and longitudinal directions and in elevation—in real time.

In some implementations, atmospheric measurements obtained by the atmospheric sensor 102 of the UAV 100 may indicate that the weather conditions at the current location of the UAV 100 are relatively calm. The UAV 100 remaining at the current location to obtain additional measurements may be of limited use due to the lack of changing atmospheric conditions. In such situations, the UAV 100 may travel to a new location that is expected to provide more useful measurements. In some examples, a processing component on board the UAV 100 can make the determination to travel to a new location automatically, e.g., without human intervention. Weather sensors without such transportation capabilities may remain in place and collect duplicative data.

In some implementations, the locations to which the UAV 100 is configured to travel may be based on one or more current or previously-obtained atmospheric measurements. In this way, the UAV 100 may be instructed to move to a particular location to collect additional (e.g., new) atmospheric measurements based on information obtained or inferred from atmospheric measurements. In an example, wind speed measurements, wind direction measurements, barometric pressure measurements, etc. obtained by the atmospheric sensor 102 may indicate that atmospheric conditions of interest are likely present to the northeast of the current location of the UAV 100. In response, the UAV 100 may travel in a northeast direction. In another example, wind speed measurements, wind direction measurements, barometric pressure measurements, etc. obtained by the atmospheric sensor 102 may indicate that atmospheric conditions of interest are likely present at a higher altitude than the UAV 100 is presently located, and in response, the UAV 100 may begin to ascend. The instruction provided to the UAV 100 that causes the UAV 100 to travel may be manual (e.g., based on input provided by a user who is controlling the UAV 100) or automatic (e.g., based on a set of rules that consider current and previous atmospheric measurements).

Whether the UAV 100 is adjusting its position laterally relative to the surface of the Earth or adjusting its altitude, the UAV 100 may be configured to travel in a given direction until atmospheric measurements having certain characteristics are obtained. For example, the UAV 100 may cease traveling and maintain its current position upon one or more atmospheric measurements obtained by the atmospheric sensor 102 satisfying a threshold. In some implementations, a combination of atmospheric measurements satisfying one or more corresponding thresholds may result in the UAV 100 halting and maintaining its current position.

In particular, the UAV 100 may maintain its current position if atmospheric measurements indicate that valuable data may be obtained at the current location. In some implementations, the UAV 100 may maintain its current position until one or more atmospheric measurements satisfy a different threshold. In particular, the UAV 100 may resume travel if atmospheric measurements indicate that duplicative data is being obtained (e.g., due to calm or uninteresting weather conditions at the current location).

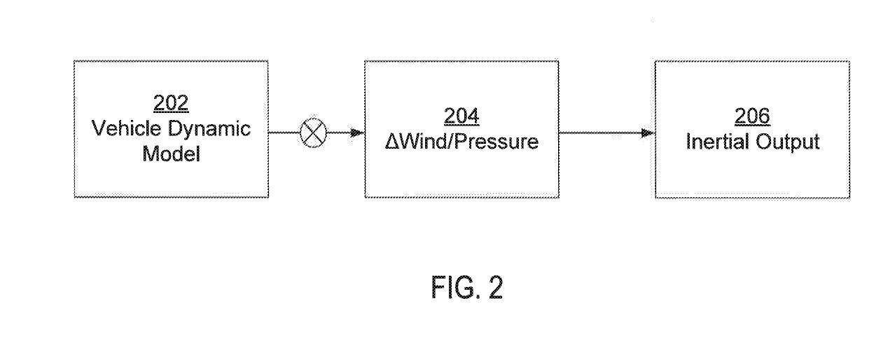

In addition to the enhanced travel capabilities of the UAV 100 relative to traditional weather probes, the UAV 100 is also better suited for sensing the atmospheric conditions that are useful for making weather forecasts, studying weather, studying climate, etc. For example, because of the inherent flight dynamics of the UAV 100, it is more sensitive to measurements of various atmospheric conditions. In some implementations, atmospheric conditions can be measured or inferred based on a response of the UAV 100 to such atmospheric conditions. The relationship between a vehicle dynamic model and an inertial output of the vehicle may be given by the following simplified equation, which is also illustrated in FIG. 2:

[Vehicle Dynamic Model]×[ΔWind/Pressure]=[Inertial Output] (1)

where [Vehicle Dynamic Model] represents the mathematical model of the UAV 100 (202 of FIG. 2), [ΔWind/Pressure] represents changes in wind speed, wind direction, and atmospheric pressure (204 of FIG. 2), and [Inertial Output] represents the inertial output of the UAV 100 (206 of FIG. 2). In some implementations, the [ΔWind/Pressure] term of the equation can include changes in other atmospheric conditions that may have an effect on the inertial output of the UAV 100.

During typical operation of the UAV 100, an avionics system including a flight controller (e.g., such as a Px4 flight controller manufactured by Pixhawk®) may actively provide stability to the rotors 106 and the propellers 108. For example, the avionics system may communicate with one or more motion, position, rotation, and/or orientation sensors (e.g., accelerometer, gyroscope, global positioning device, etc.) that are included in the UAV 100 to identify changes in the motion, position, rotation, or orientation of the UAV 100 due to external elements (e.g., wind). In response, the flight controller can provide instructions to the rotors 106 to cause the rotors 106 to adjust their power output such that the instability caused by external factors is neutralized.

As an example, suppose the UAV 100 is instructed (e.g., by a user) to maintain a straight and level hover position, but a wind gust causes the UAV 100 to roll three degrees to the right about a roll axis of the UAV 100. Unless such a change in position is compensated for, the UAV 100 will fly to the right rather than maintaining its straight and level hover position. Using information provided by one or more motion, position, rotation, or orientation sensors, the flight controller can identify the change of position of the UAV 100 and cause the rotors 106 located on the right side of the UAV 100 to increase their power output to a degree that negates the effect of the wind gust.

Once an accurate dynamic mathematical model of the UAV 100 is created, the flight controller may be designed using simulations that apply different weather conditions onto the model of the UAV 100 to determine the estimated inertial output. Using such simulations, the flight controller can be programmed to appropriately respond to and compensate for certain external forces so that the UAV 100 can operate as instructed. Similar principles can be utilized to obtain useful atmospheric data based on the reaction of the UAV 100 to atmospheric conditions. For example, because the inertial output of the UAV 100 can be accurately measured (e.g., using motion, position, rotation, and orientation sensors), the vehicle dynamic model given by Equation (1) can be used to calculate changes in atmospheric conditions such as changes in wind speed, wind direction, and pressure. In other words, a reverse simulator from the actual inertial output and vehicle dynamics of the UAV 100 can be used to determine weather conditions at the current location of the UAV 100. Atmospheric measurements that may be obtained using such reverse simulations include wind directionality, wind gusts, maximum/minimum/mean wind vectors, pressure variance, etc. Further, the fidelity of the atmospheric measurements is increased due to the presence of the plurality of rotors 106. In some implementations, the fidelity of the atmospheric measurements can be further improved by including additional rotors 106 (e.g., more than six).

For example, suppose the flight controller is configured to increase the power provided to the front rotors 106 by 1% per degree of rotation experienced by the UAV 100 about a pitch axis in the front direction. Such an adjustment may allow the UAV 100 to negate the external effects that caused the change in position. Using Equation (1) and known simulation data, the control signals provided by the flight controller (e.g., the compensatory control signals) can be used to infer the atmospheric conditions that caused the change in position. In this way, actual values for changes of various weather conditions can be determined.

In some implementations, the inertial output of the UAV 100 is measured by an inertial measurement unit (IMU) that is configured to measure and report information such as a specific force and angular rate of the UAV 100. The IMU can include one or more accelerometers, gyroscopes, magnetometers, etc.

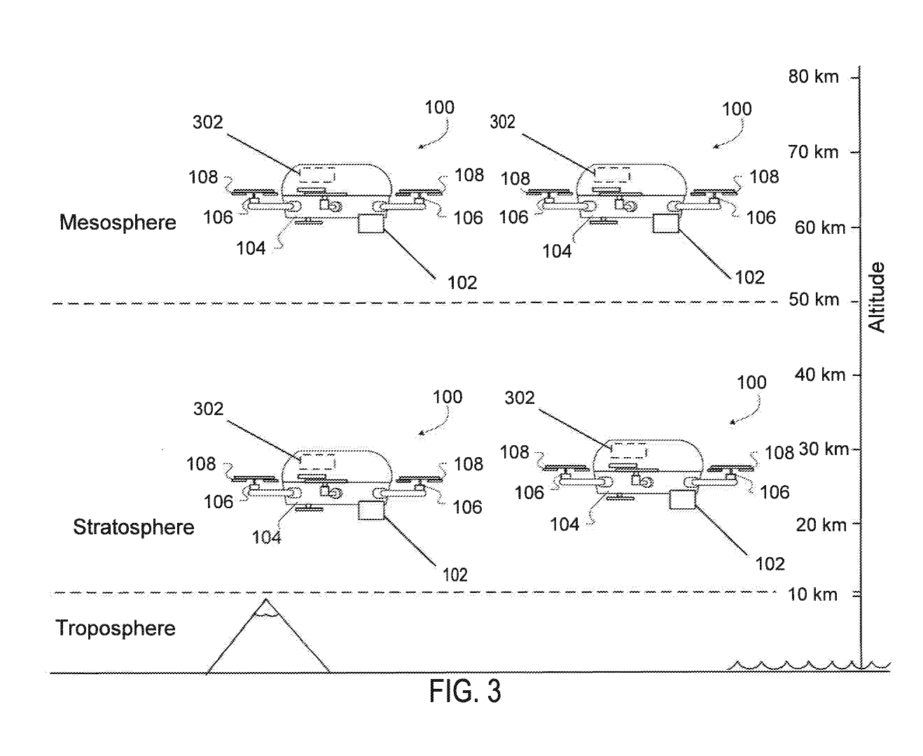

In some implementations, a plurality of UAVs 100 may be used to individually or collectively sense weather conditions. FIG. 3 shows an example of a sensor network 300 that includes a plurality of UAVs 100. The sensor network 300 can be used, e.g., to determine a synchronized macro weather model. In some examples, a plurality of UAVs 100 (e.g., tens, hundreds, thousands, etc.) may be deployed across a geographic area at various altitudes to determine a synchronized macro weather model. In this way, the sensor network 300 can gather valuable atmospheric measurement information at various different locations simultaneously, thereby providing data that is more thorough and/or more accurate than that which is gathered by single-point sensor implementations. For example, weather prediction systems typically use mathematical models of the atmosphere to predict future weather based on current weather conditions. Such mathematical models rely on input data from weather sensors to determine current weather conditions in real-time. Additional input data, and in particular input data with high fidelity, allow the mathematical models to provide improved results. Input data provided by a plurality of atmospheric sensors (e.g., the atmospheric sensors 102 of the plurality of UAVs 100) across a geographic area can provide the mathematical models with data of the quality and quantity suitable to maximize the accuracy of weather predictions.

In some implementations, each UAV 100 includes a positional system such as a global positioning system (GPS) 302 for identifying the current location of the UAV 100. The GPS 302 may provide the location of the UAV 100 in terms of latitudinal and longitudinal coordinates. In some implementations, the GPS 302 may also provide information that can be used to determine the altitude of the UAV 100. In some implementations, a barometer (e.g., a barometer that is part of the atmospheric sensor 102) may be used to determine the altitude of the UAV 100. The current location of the UAV 100 can be mapped to the other atmospheric measurements made by the atmospheric sensor 102 to determine weather conditions that exist at a particular location (e.g., a particular longitude, latitude, and altitude) at a particular time. Such information may be provided to a mathematical weather model, and by employing numerical weather prediction and computer simulation techniques, future weather conditions can be predicted.

In some implementations, the UAVs 100 may be instructed to remain at a fixed location (e.g., at a fixed longitude, latitude, and altitude) as atmospheric measurements are collected. For example, the avionics systems and the flight controllers of the UAVs 100 may provide compensatory flight instructions to the respective UAVs 100 to ensure that the UAVs 100 maintain a straight and level hover. The compensatory flight instructions may be used to infer one or more weather conditions that exist at the current location of the respective UAV 100 using the approach described above with respect to FIG. 2. For example, if the compensatory flight instructions cause the UAV 100 to increase power to all rotors 106 equally in order to maintain the straight and level hover, this may indicate that a low pressure condition having a particular magnitude exists at the location of the UAV 100, or a wind gust having a particular magnitude has occurred in a downwards direction over the UAV 100.

In some implementations, the UAVs 100 may be instructed to freely travel (e.g., by accepting limited compensatory flight instructions) according to the external weather conditions that exist. For example, wind gusts may cause the UAVs 100 to travel to various locations. The directions and distances that each UAVs 100 travels may be used to infer information about the weather conditions that the UAVs 100 travel through. For example, suppose one of the UAVs 100 travels in a north direction over a particular period of time. Positional information provided by the GPS 302 may be used to determine exactly where the UAV 100 traveled from and to, and the time period can be used to determine the average and instantaneous velocities of the UAV 100 over the course of travel. Such information can be used to infer characteristics of the wind (e.g., wind speed, wind direction, etc.) over the course of travel of the UAV 100.

In some implementations, the UAVs 100 may receive travel instructions that cause the sensor network 300 to travel as a group. For example, the UAVs 100 may be instructed to scan a particular geographic region (e.g., by “patrolling” the region). In some implementations, the sensor network 300 may be instructed to travel to a first particular geographic region, collect a particular number of atmospheric measurements, travel to a second particular geographic region, collect a particular number of atmospheric measurements, etc. In some implementations, the sensor network 300 may be instructed to remain in a particular geographic region for a particular amount of time before traveling to the next region. In some implementations, the sensor network 300 may be instructed to remain in a particular geographic region so long as the atmospheric measurements provide useful information. For example, the sensor network 300 may remain in a particular geographic region until the weather assumes a relatively calm state (e.g., as determined by whether one or more atmospheric measurements satisfy corresponding thresholds).

In some implementations, the UAVs 100 of the sensor network 300 may be instructed to travel and gather atmospheric measurements according to a set of predefined rules. For example, the sensor network 300 may infer locations at which valuable atmospheric measurements could be made based on one or more current or previously-obtained atmospheric measurements. For example, current and previous wind and pressure measurements may indicate that inclement weather is present to the east of the current location of the sensor network 300. In response, the sensor network 300 may be automatically instructed to travel east. The particular locations of increment weather may be based on information provided by a mathematical weather model that utilizes computer simulations. The mathematical weather model may consider atmospheric measurements currently provided or previously provided by the atmospheric sensors 102 of the UAVs 100.

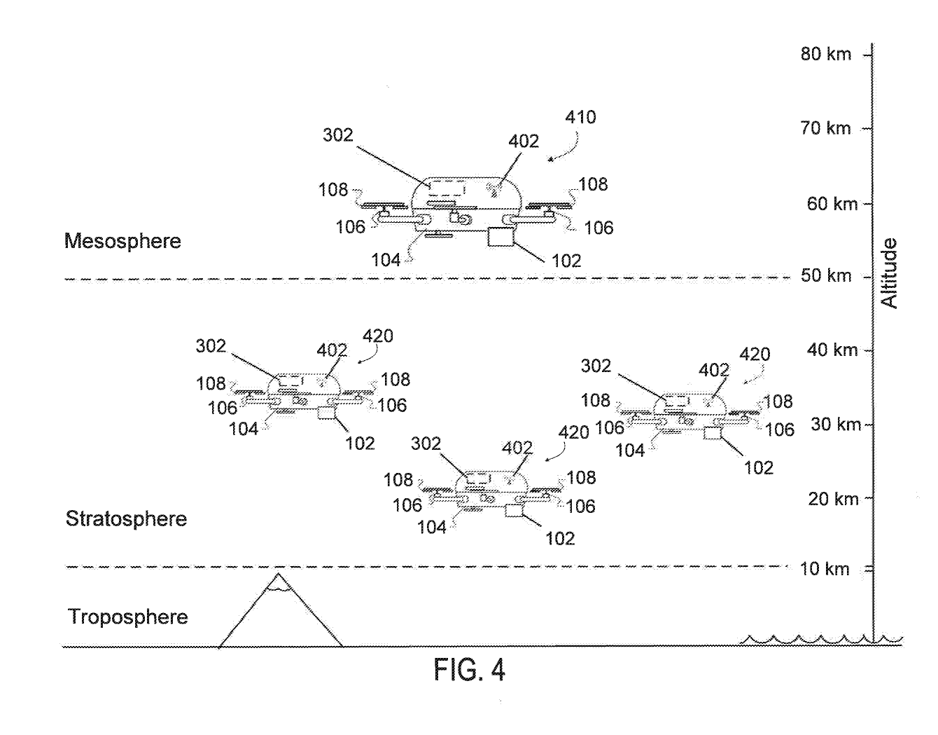

FIG. 4 shows another example of a sensor network 400 that includes a plurality of UAVs. In this example, the sensor network 400 includes a master UAV 410 and a plurality of slave UAVs 420. The master UAV 410 and slave UAVs 420 may include the components of the UAVs 100 described above with respect to FIGS. 1-3, as well as additional components.

The master UAV 410 and each of the slave UAVs 420 include a transceiver 402 configured to transmit and receive communications. In some implementations, the transceiver 402 of the master UAV 410 is configured to communicate according to a long range communication protocol to allow the master UAV 410 to transmit and receive information to and from a remote entity. For example, the transceiver 402 of the master UAV 410 may be configured to communicate with the remote entity using a cellular communication protocol such as GSM, CDMA, AMPS, etc. In some implementations, the transceiver 402 of the slave UAVs 420 are configured to communicate according to a short-range communication protocol. For example, the transceivers 402 of the slave UAVs 420 may be configured to communicate with each other and with the master UAV 410 using WiFi, Bluetooth, etc.

In some implementations, the master UAV 410 may receive instructions from the remote entity and in turn provide instructions to the plurality of slave UAVs 420. In some implementations, the master UAV 410 may receive instructions from the remote entity and in turn provide the instructions to one of the slave UAVs 420, and the slave UAV 420 may provide the instructions to another one of the slave UAVS 420, and so on until all slave UAVs 420 receive the instructions. The instructions may include flight instructions for controlling the movement of the UAVS 410, 420. For example, a remote user may instruct the master UAV 410 to travel to a particular location to gather atmospheric measurements, and in response, the master UAV 410 and the corresponding slave UAVs 420 may travel to the identified location. In some implementations, the remote entity is a computer system that automatically generates travel instructions (e.g., based on one or more current or previous atmospheric measurements received by the UAVs 410, 420).

In some implementations, the instructions inform the master UAV 410 (and in turn, the slave UAVs 420) of the types of data to be collected by the atmospheric sensors of the UAVs 410, 420. For example, the UAVs 410, 420 may be instructed to gather wind speed and direction measurements and transmit such measurements back to the remote entity. The instructions may include a frequency at which such measurements are to be obtained. For example, the remote entity may instruct the UAVs 410, 420 to make wind speed and direction measurements at an interval of every second, every minute, every five minutes, every half hour, etc. In some implementations, the UAVs 410, 420 may make the instructed measurements at the instructed interval, but the master UAV 410 may transmit the measurements according to a different interval. For example, the UAVs 410, 420 may make wind speed and direction measurements every minute, but the master UAV 410 may provide the measurements to the remote entity every hour.

While the sensor network 400 is depicted as including a single master UAV 410, in some implementations, additional master UAVs 410 may be included. In some implementations, each UAV may be equipped with the capabilities of the master UAV 410. In other words, in some implementations, all UAVs may be master UAVs 410 that are configured to receive and execute instructions (e.g., from a remote user). In some examples, the sensor network 400 can be implemented as a mesh network in which each UAV in the sensor network 400 acts as a node.

As compared to traditional weather probes and weather stations, sensor networks 300, 400 including a plurality of UAVs 100 such as those described above can provide data of a quantity and fidelity that is impracticable using existing systems. For example, a weather station operating independently is typically only able to collect atmospheric data at a given fixed location, or perhaps at a limited number of fixed locations. Gathering data from fixed locations leads to a number of fundamental shortcomings. For example, the weather conditions that exists at the particular location of the measurement equipment may be different than weather conditions that exist at surrounding locations, even surrounding locations that are relatively close by. The presence of surrounding structures, both man-made and natural, may exacerbate these differences. For example, surrounding buildings or trees may cause rainfall, wind direction, wind speed, etc. measurements to inaccurately reflect the actual weather conditions in the region. Such structures may influence the wind gusts that form. In contrast, the UAVs 100 described above are capable of traveling to locations where weather conditions can be measured in their true, uninterrupted form.

Further, because the sensor networks 300, 400 include a plurality of UAVs 100 that are configured to gather atmospheric data at multiple different locations simultaneously, discrepancies between data collected at nearby locations can be identified and accounted for. For example, one or more of the UAVs 100 of the sensor network 300, 400 may obtain data measurements that do not appear to accurately reflect the measurements obtained by the rest of the UAVs 100. This may be due to those one or more UAVs 100 being positioned at locations where the weather is artificially influenced by surrounding structures. The sensor network 300, 400 may be configured to identify such outlier data and discount it. In some implementations, outlier data may be filtered by the remote entity (e.g., a computer program running on a remote server) after the data is provided. In some implementations, one or more statistical models may be applied to the data provided by the sensor network 300, 400 to identify outlier data. Such data filtering and outlier detection is impracticable in systems that utilize a limited number of atmospheric sensors, and in particular a limited number of atmospheric sensors at fixed locations.

While the UAVs 100 are largely depicted in the figures as being located in the stratosphere, the UAVs 100 may be located elsewhere. For example, in some implementations, the UAVs 100 can travel to and through the troposphere, the mesosphere, etc.

In some implementations, the UAV 100 can be powered by a micro hybrid generator system that provides a small portable micro hybrid generator power source with energy conversion efficiency. In UAV applications, the micro hybrid generator system can be used to overcome the weight of the vehicle, the micro hybrid generator drive, and fuel used to provide extended endurance and payload capabilities in UAV applications.

The micro hybrid generator system can include two separate power systems. A first power system included as part of the micro hybrid generator system can be a small and efficient gasoline powered engine coupled to a generator motor. The first power system can serve as a primary source of power of the micro hybrid generator system. A second power system, included as part of the micro hybrid generator system, can be a high energy density rechargeable battery. Together, the first power system and the second power system combine to form a high energy continuous power source and with high peak power availability for a UAV. In some examples, one of the first power system and the second power system can serve as a back-up power source of the micro hybrid generator system if the other power system experiences a failure.

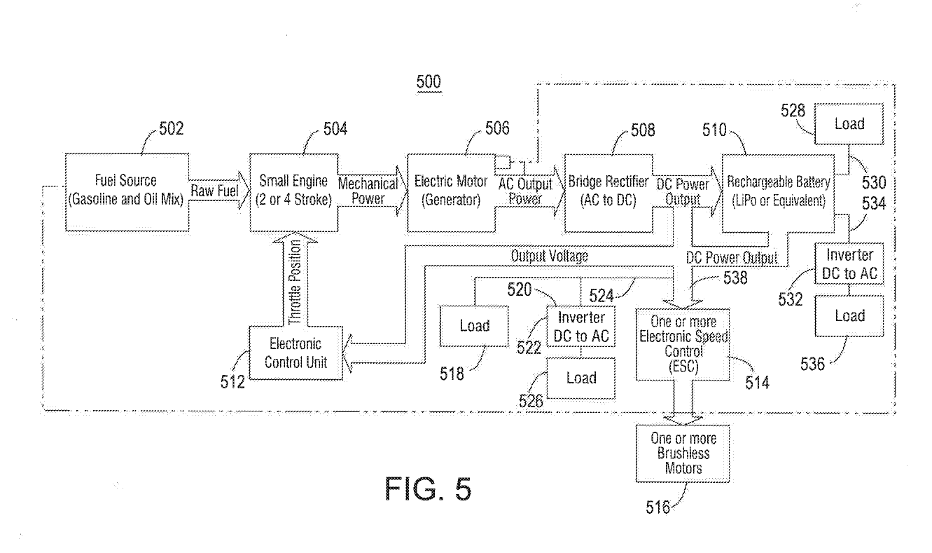

FIG. 5 shows a diagram of an example micro hybrid generator system 500. The micro hybrid generator system 500 includes a fuel source 502 (e.g., a vessel) for storing gasoline, a mixture of gasoline and oil mixture, or similar type fuel or mixture. The fuel source 502 provides fuel to a small engine 504 of a first power system. The small engine 504 can use the fuel provided by the fuel source 502 to generate mechanical energy. In some examples, the small engine 504 can have dimensions of about 12″ by 11″ by 6″ and a weight of about 3.5 lbs to allow for integration in a UAV. In some examples, the small engine 504 may be an HWC/Zenoah G29 RCE 3D Extreme available from Zenoah, 1-9 Minamidai Kawagoe, Saitama 350-2025, Japan. The micro hybrid generator system 500 also includes a generator motor 506 coupled to the small engine 504. The generator motor 506 functions to generate AC output power using mechanical power generated by the small engine 504. In some examples, a shaft of the small engine 504 includes a fan that dissipates heat away from the small engine 504. In some examples, the generator motor 506 is coupled to the small engine 504 through a polyurethane coupling.

In some examples, the micro hybrid generator system 500 can provide 1.8 kW of power. The micro hybrid generator system 500 can include a small engine 504 that provides approximately 3 horsepower and weighs approximately 1.5 kg. In some examples, the small engine 504 may be a Zenoah® G29RC Extreme engine. The micro hybrid generator system 500 can include a generator motor 506 that is a brushless motor, such as a 380 Kv, 8 mm shaft, part number 5035-380, available from Scorpion Precision Industry®.

In some examples, the micro hybrid generator system 500 can provide 10 kW of power. The micro hybrid generator system 500 can include a small engine 504 that provides approximately between 15-16.5 horsepower and weighs approximately 7 pounds. In some examples, the small engine 504 is a Desert Aircraft® D-150. The micro hybrid generator system 500 can include a generator motor 506, such as a Joby Motors® JM1 motor.

The micro hybrid generator system 500 includes a bridge rectifier 508 and a rechargeable battery 510. The bridge rectifier 508 is coupled between the generator motor 506 and the rechargeable battery 510 and converts the AC output of the generator motor 506 to DC power to charge the rechargeable battery 510 or provide DC power to load 518 by line 520 or power to DC-to-AC inverter 522 by line 524 to provide AC power to load 526. The rechargeable battery 510 may provide DC power to load 528 by line 530 or to DC-to-AC inverter 532 by line 534 to provide AC power to load 536. In some examples, an output of the bridge rectifier 508 and/or the rechargeable battery 510 of micro hybrid generator system 500 is provided by line 538 to one or more electronic speed control devices (ESC) 514 integrated in one or more rotor motors 516 as part of a UAV. The ESC 514 can control the DC power provided by bridge rectifier 508 and/or rechargeable battery 510 to one or more rotor motors provided by generator motor 506. In some examples, the ESC 514 can be a T-Motor® ESC 45A (2-6S) with SimonK. In some examples, the bridge rectifier 508 can be a model #MSD100-08, diode bridge 800V 100A SM3, available from Microsemi Power Products Group®. In some examples, active rectification can be applied to improve efficiency of the micro hybrid generator system.

In some examples, the ESC 514 can control an amount of power provided to one or more rotor motors 516 in response to input received from an operator. For example, if an operator provides input to move a UAV to the right, then the ESC 514 can provide less power to rotor motors 516 on the right of the UAV to cause the rotor motors to spin propellers on the right side of the UAV slower than propellers on the left side of the UAV. As power is provided at varying levels to one or more rotor motors 516, a load (e.g., an amount of power provided to the one or more rotor motors 516) can change in response to input received from an operator.

In some examples, the rechargeable battery 510 may be a LiPo battery, providing 3000 mAh, 22.2V 65 C, Model PLU65-30006, available from Pulse Ultra Lipo®, China. In some examples, the rechargeable battery 510 may be a lithium sulfur (LiSu) rechargeable battery or similar type of rechargeable battery.

The micro hybrid generator system 500 includes an electronic control unit (ECU) 512. The ECU 512, and other applicable systems described herein, can be implemented as a computer system, a plurality of computer systems, or parts of a computer system or a plurality of computer systems. The computer system may include a processor, memory, non-volatile storage, and an interface. A typical computer system will usually include at least a processor, memory, and a device (e.g., a bus) coupling the memory to the processor. In some examples, the processor may be a general-purpose central processing unit (CPU), such as a microprocessor, or a special-purpose processor, such as a microcontroller.

In some examples, the memory can include random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data may be written, by a direct memory access process, into memory during execution of software on the computer system. The non-volatile storage can be local, remote, or distributed. The non-volatile storage may be optional because systems can be created with all applicable data available in memory.

Software is typically stored in the non-volatile storage. In some examples (e.g., for large programs), it may not be practical to store the entire program in the memory. Nevertheless, it should be understood that the software may be moved to a computer-readable location appropriate for processing, and for illustrative purposes, that location is referred to as the memory herein. Even when software is moved to the memory for execution, the processor will typically make use of hardware registers to store values associated with the software, and local cache that, in some examples, serves to speed up execution. As used herein, a software program may be stored at an applicable known or convenient location (e.g., from non-volatile storage to hardware registers) when the software program is referred to as “implemented in a computer-readable storage medium.” A processor is considered to be “configured to execute a program” when at least one value associated with the program is stored in a register readable by the processor.

In some examples of operation, a computer system can be controlled by operating system software, such as a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. In some examples, the I/O devices can include a keyboard, a mouse or other pointing device, disk drives, printers, a scanner, and other I/O devices, including a display device. In some examples, the display device can include a cathode ray tube (CRT), liquid crystal display (LCD), or some other applicable known or convenient display device. The interface can include one or more of a modem or network interface. It will be appreciated that a modem or network interface can be considered to be part of the computer system. The interface can include one or more of an analog modem, isdn modem, cable modem, token ring interface, Ethernet interface, satellite transmission interface (e.g. “direct PC”), or other interfaces for coupling a computer system to other computer systems. Interfaces enable computer systems and other devices to be coupled together in a network.

A computer system can be implemented as a module, as part of a module, or through multiple modules. As used herein, a module can include one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the module's functionality, or the like. As such, a first module and a second module can have one or more dedicated processors, or a first module and a second module can share one or more processors with one another or other modules. Depending upon implementation-specific or other considerations, in some examples, a module can be centralized or its functionality distributed. A module can include hardware, firmware, or software embodied in a computer-readable medium for execution by the processor. The processor can transform data into new data using implemented data structures and methods, such as is described with reference to the figures included herein.

The ECU 512 is coupled to the bridge rectifier 508 and the rechargeable battery 510. The ECU 512 can be configured to measure the AC voltage of the output of the generator motor 506, which is directly proportional to the revolutions per minute (RPM) of the small engine 504, and compares it to the DC power output of the bridge rectifier 508. The ECU 512 can control the throttle of the small engine 504 to cause the DC power output of the bridge rectifier 508 to increase or decrease as the load changes (e.g., a load of one or more electric motors 516 or one or more of loads 518, 526, 528, and 536). In some examples, the ECU 512 can be an Arduino® MEGA 2560 Board R3, available from China. In various embodiments, a load of one or more electric motors 516 can change as the ESC 514 changes an amount of power provided to the electric motors 516. For example, if a user inputs to increase the power provided to the electric motors 516 subsequently causing the ESC 514 to provide more power to the electric motors 516, then the ECU 512 can increase the throttle of the small engine 504 to cause the production of more power to be provided to the electronic motors 516.

The ECU 512 can function to maintain voltage output of loads by reading the sensed analog voltage, converting the sensed analog voltage to ADC counts, comparing the count to that corresponding to a desired voltage, and increasing or decreasing the throttle of the small engine 504 according to the programmed gain if the result is outside of the dead band.

In some examples, the micro hybrid generator system 500 can provide about 1,800 watts of continuous power, 10,000 watts of instantaneous power (e.g., 6 S with 16,000 mAh pulse battery) and has a 1,500 Wh/kg gasoline conversion rate. In some examples, the micro hybrid generator system 500 has dimensions of about 12″ by 12″ by 12″ and a weight of about 8 lbs.

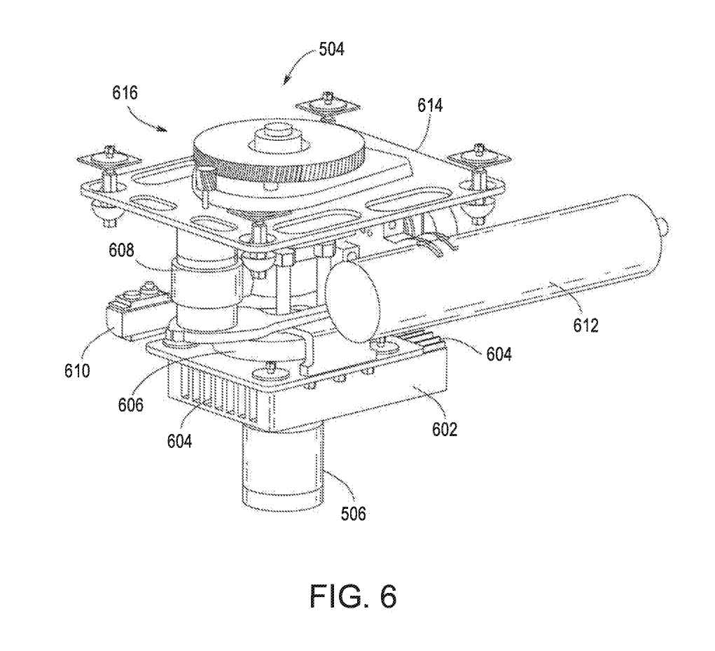

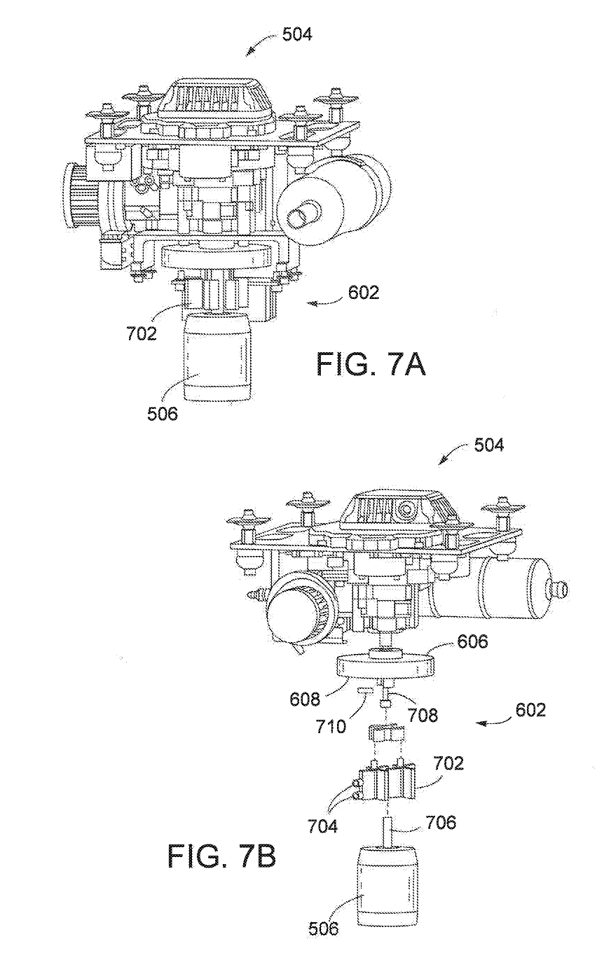

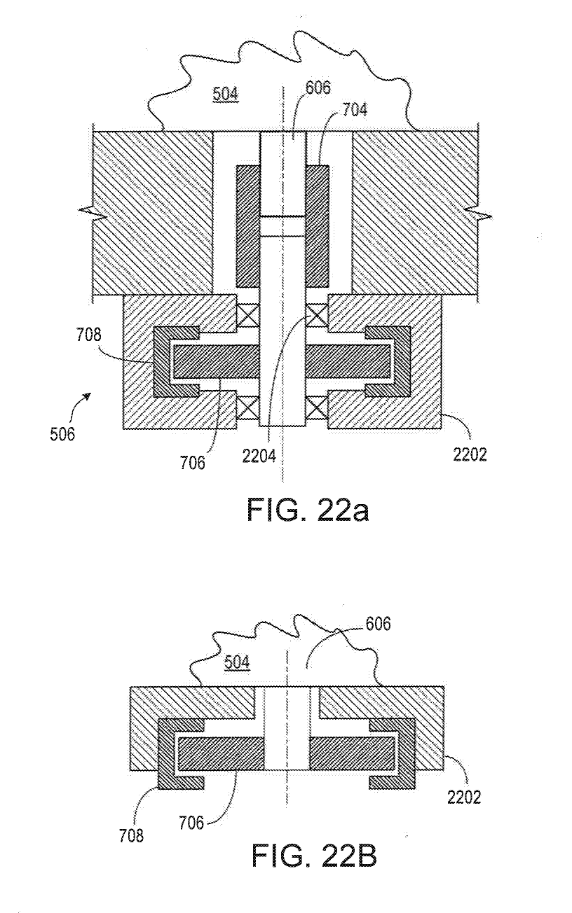

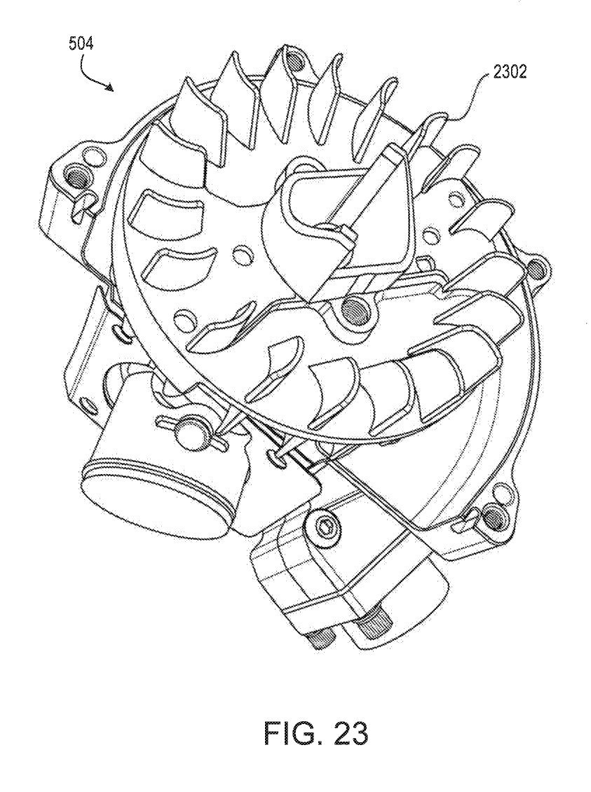

FIG. 6 shows a side perspective view of a micro hybrid generator system 500. FIG. 7A shows a side view of a micro hybrid generator 500. FIG. 7B shows an exploded side view of a micro hybrid generator 500. The micro hybrid generator system 500 includes a small engine 504 coupled to generator motor 506. In one embodiment, the small engine 504 includes a coupling/cooling device 602 which provides coupling of the shaft of the generator motor 506 to the shaft of small engine 504 and also provides cooling with sink fins 604. For example, FIGS. 7A and 7B show in further detail one embodiment of coupling/cooling device 602, which includes coupling/fan 702 with set screws 704 that couple shaft 706 of generator motor 506 and shaft 708 of small engine 504. Coupling/cooling device 602 may also include rubber coupling ring (2202 of FIG. 22A).

In some examples, the micro hybrid generator system 500 includes components to facilitate transfer of heat away from the micro hybrid generator system 500 and/or is integrated within a UAV to increase airflow over components that produce heat. For example, the hybrid generator system 500 can include cooling fins on specific components (e.g. the rectifier) to transfer heat away from the micro hybrid generator system. In some examples, the micro hybrid generator system 500 includes components and is integrated within a UAV to cause heat to be transferred towards the exterior of the UAV.

In some examples, the micro hybrid generator system 500 and/or a UAV integrating the micro hybrid generator system 500 is configured to allow 406 cubic feet per minute of airflow across at least one component of the micro hybrid generator system 500. A small engine 504 of the micro hybrid generator system 500 can be run at an operating temperature 150° C. and if an ambient temperature in which the micro hybrid generator system 500, in order to remove heat generated by the small engine 506, an airflow of 406 cubic feet per minute is achieved across at least the small engine 506. Further, in some examples, the small engine 506 is operated at 16.5 Horsepower and generates 49.2 kW of waste heat (e.g. each head of the small engine produces 24.6 kW of waste heat). In some examples, engine heads of the small engine 506 of the micro hybrid generator system 500 are coupled to electric ducted fans to concentrate airflow over the engine heads. For example, 406 cubic feet per minute airflow can be achieved over engine heads of the small engine 506 using electric ducted fans.

In some examples, the micro hybrid generator system 500 is integrated as part of a UAV using a dual vibration damping system. A small engine 506 of the micro hybrid generator system can utilize couplings to serve as dual vibration damping systems. In some examples, the small engine 506 produces a mean torque of 1.68 Nm at 10,000 RPM. In some examples, a urethane coupling is used to couple at least part of the micro hybrid generator system 500 to a UAV. Further, in some examples, the urethane coupling can have a durometer value of between 90 A to 75 D. Example urethane couplings used to secure at least part of the micro hybrid generator system 500 to a UAV include L42 Urethane, L100 Urethane, L167 Urethane, and L315 Urethane. Urethane couplings used to secure at least part of the micro hybrid generator system 500 to a UAV can have a tensile strength between 20 MPa and 62.0 MPa, between 270 to 800% elongation at breaking, a modulus between 2.8 MPa and 32 MPa, an abrasion index between 110% and 435%, and a tear strength split between 12.2 kN/m and 192.2 kN/m.

The small engine 504 also includes a fly wheel 606 which can reduce mechanical noise and/or engine vibration. In some examples, small engine 504 includes a Hall-Effect sensor (710 of FIG. 7A) and a Hall Effect magnet coupled to fly wheel 606, as shown. In some examples, the Hall-effect sensor 710 may be available from RCexl Min Tachometer®, Zhejiang Province, China.

When small engine 504 is operational, fly wheel 606 spins and generates a voltage which is directly proportional to the revolutions per minute of fly wheel 606. This voltage is measured by Hall-effect sensor 710 and is input into an ECU 512. The ECU 512 compares the measured voltage to the voltage output by generator motor 506. ECU 512 will then control the throttle of either or both the generator motor 506 and the small engine 504 to increase or decrease the voltage as needed to supply power to one or more of loads 518, 526, 528, and/or 536 or one or more rotor motors 516.

Small engine 504 may also include a starter motor 608, servo 610, muffler 612, and vibrational mount 614.

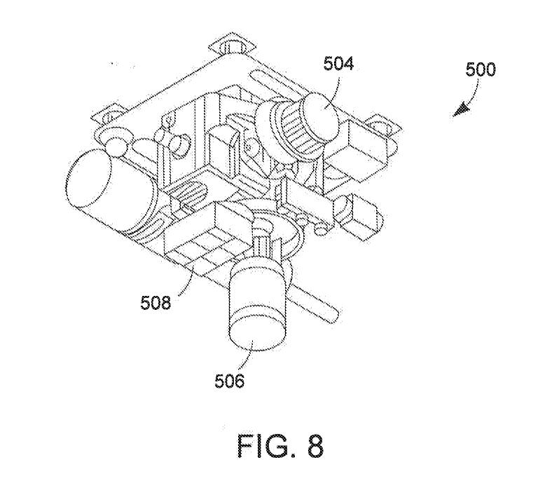

FIG. 8 shows a perspective view of a micro hybrid generator system 500. The micro hybrid generator system 500 includes a small motor 504 and generator motor 506 coupled to a bridge rectifier 508.

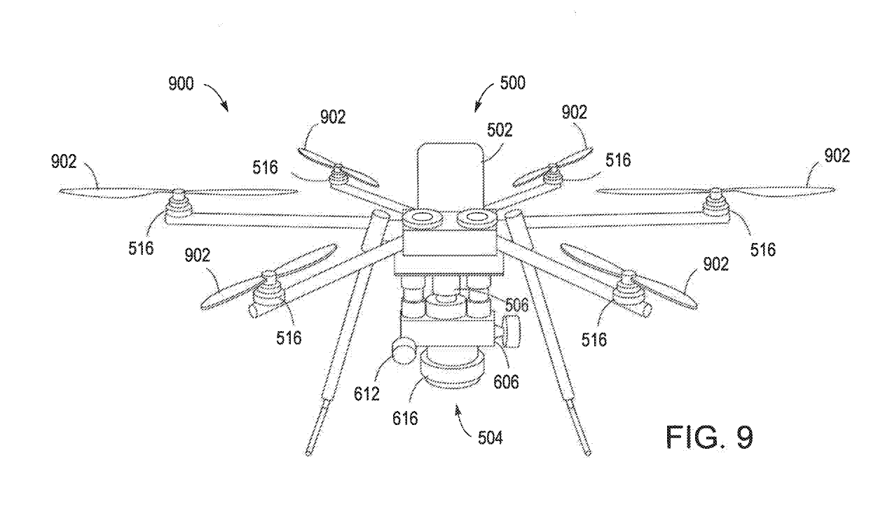

FIG. 9 shows a perspective view of a UAV 900 integrated with a micro hybrid generator system 500. The UAV 900 includes six rotor motors 516 each coupled to propellers 902, however it is appreciated that a UAV integrated with a micro hybrid generator system 500 can include more or fewer rotor motors and propellers. The UAV 900 can include a Px4 flight controller manufactured by Pixhawk®.

In some examples, the small engine 504 may be started using an electric starter (616 of FIGS. 6 and 9). Fuel source 502 can deliver fuel to small engine 504 to spin its rotor shaft directly coupled to generator motor 506 (e.g., as shown in FIG. 7) and applies a force to generator motor 506. The spinning of generator motor 506 generates electricity and the power generated by motor generator 506 is proportional to the power applied by shaft of small engine 504. In some examples, a target rotational speed of generator motor 506 is determined based on the KV (rpm/V) of generator motor 506. For example, if a target voltage of 25 Volt DC is desired, the rating of generator motor 506 may be about 400 KV. The rotational speed of the small engine 504 may be determined by the following equations:

RPM=KV (RPM/Volt)×Target Voltage (VDC) (2)

RPM=400 KV×25 VDC (3)

RPM=10,000 (4)

In this example, for generator motor 506 to generate 25 VDC output, the shaft of generator motor 506 coupled to the shaft of small engine 504 needs to spin at about 10,000 RPM.

As the load (e.g., one or more motors 516 or one or more of loads 518, 526, 528, and/or 536) is applied to the output of generator motor 506, the voltage output of the micro hybrid generator system 500 will drop, thereby causing the speed of small engine 504 and generator motor 506 to be reduced. In some examples, ECU 512 can be used to help regulate the throttle of small engine 504 to maintain a consistent output voltage that varies with loads. ECU 512 can act in a manner similar to that of a standard governor for gasoline engines, but instead of regulating an RPM, the ECU 512 can regulate a target voltage output of either or both a bridge rectifier and a generator motor 506 based on a closed loop feedback controller.

Power output from generator motor 506 can be in the form of alternating current (AC) which may need to be rectified by bridge rectifier 508. Bridge rectifier 508 can convert the AC power into direct current (DC) power, as discussed above. In some examples, the output power of the micro hybrid generator system 500 can be placed in a “serial hybrid” configuration, where the generator power output by generator motor 506 may be available to charge the rechargeable battery 510 or provide power to another external load.

In operation, there can be at least two available power sources when the micro hybrid generator system 500 is functioning. A primary source can be from the generator motor 506 through directly from the bridge rectifier and a secondary power source can be from the rechargeable battery 510. Therefore, a combination of continuous power availability and high peak power availability is provided, which may be especially well-suited for UAV applications or portable generator applications. In cases where either primary power source (e.g., generator motor 506) is not available, system 500 can still continue to operate for a short period of time using power from rechargeable battery 510, thereby allowing a UAV to sustain safety strategy, such as an emergency landing.

When micro hybrid generator system 500 is used for UAVs, the following conditions can be met to operate the UAV effectively and efficiently: 1) the total continuous power (watts) can be greater than power required to sustain UAV flight, 2) the power required to sustain a UAV flight is a function of the total weight of the vehicle, the total weight of the hybrid engine, the total weight of fuel, and the total weight of the payload), where:

Total Weight (gram)=vehicle dry weight+small engine 504 weight+fuel weight+payload (5)

and, 3) based on the vehicle configuration and aerodynamics, a particular vehicle will have an efficiency rating (grams/watt) of 11, where:

Total Power Required to Fly=ηx Weight (gram) (6)

In examples in which the power required to sustain flight is greater than the available continuous power, the available power or total energy may be based on the size and configuration of the rechargeable battery 510. A configuration of the rechargeable battery 510 can be based on a cell configuration of the rechargeable battery 510, a cell rating of the rechargeable battery 510, and/or total mAh of the rechargeable battery 510. In some examples, for a 6S, 16000 mAh, 25 C battery pack, the total energy is determined by the following equations:

Total Energy=Voltage×mAh=25 VDC (6 S)×16000 mAh=400 Watt*Hours (7)

Peak Power Availability=Voltage×mAh×C Rating=25 VDC×16000 mAh×25 C 10,400 Watts (8)

Total Peak Time=400 Watt*Hours/10,400 Watts=138.4 secs (9)

Further, in some examples, the rechargeable battery 510 may be able to provide 10,400 Watts of power for 138.4 seconds in the event of primary power failure from small engine 504. Additionally, the rechargeable battery 510 may be able to provide up to 10,400 Watts of available power for flight or payload needs instantaneous peak power for short periods of time needed for aggressive maneuvers.

The result is micro hybrid generator system 500, when coupled to a UAV, efficiently and effectively provides power to fly and maneuver the UAV for extended periods of time with higher payloads than conventional multi-rotor UAVs. In some examples, the micro hybrid generator system 500 can provide a loaded (e.g., 3 lb. load) flight time of up to about 2 hours 5 minutes, and an unloaded flight time of about 2 hours and 35 minutes. Moreover, in the event that the fuel source runs out or the small engine 504 and/or the generator motor 506 malfunctions, the micro hybrid generator system 500 can use the rechargeable battery 510 to provide enough power to allow the UAV to perform a safe landing. In some examples, the rechargeable battery 510 can provide instantaneous peak power to a UAV for aggressive maneuvers, for avoiding objects, or threats, and the like.

In some examples, the micro hybrid generator system 500 can provide a reliable, efficient, lightweight, portable generator system which can be used in both commercial and residential applications to provide power at remote locations away from a power grid and for a micro-grid generator, or an ultra-micro-grid generator.

In some examples, the micro hybrid generator system 500 can be used for an applicable application (e.g., robotics, portable generators, micro-grids and ultra-micro-grids, and the like) where an efficient high energy density power source is desired and where a fuel source is readily available to convert hydrocarbon fuels into useable electric power. The micro hybrid generator system 500 has been shown to be significantly more energy efficient than various forms of rechargeable batteries (Lithium Ion, Lithium Polymer, Lithium Sulfur) and even Fuel Cell technologies typically used in conventional UAVs.

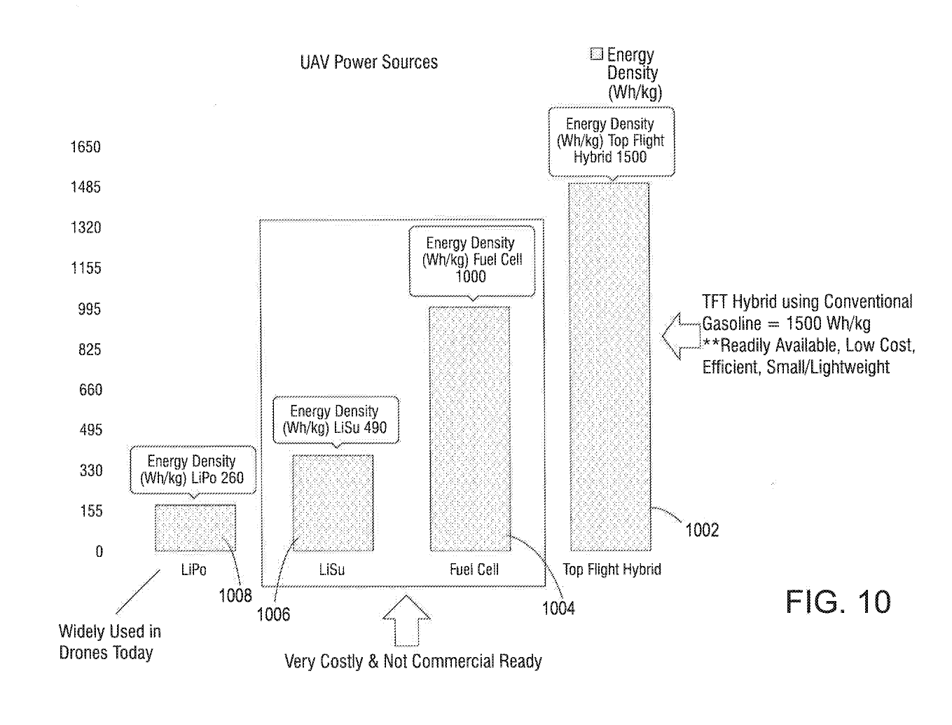

FIG. 10 shows a graph comparing energy density of different UAV power sources. In some examples, the micro hybrid generator system 500 can use conventional gasoline which is readily available at low cost and provide about 1,500 Wh/kg of power for UAV applications, as indicated at 1002 in FIG. 6. Conventional UAVs which rely entirely on batteries can provide a maximum energy density of about 1,000 Wh/kg when using an energy high density fuel cell technology, as indicated at 1004, about 400 Wh/kg when using lithium sulfur batteries, as indicated at 1006, and about 200 Wh/kg when using a LiPo battery, as indicated at 1008.

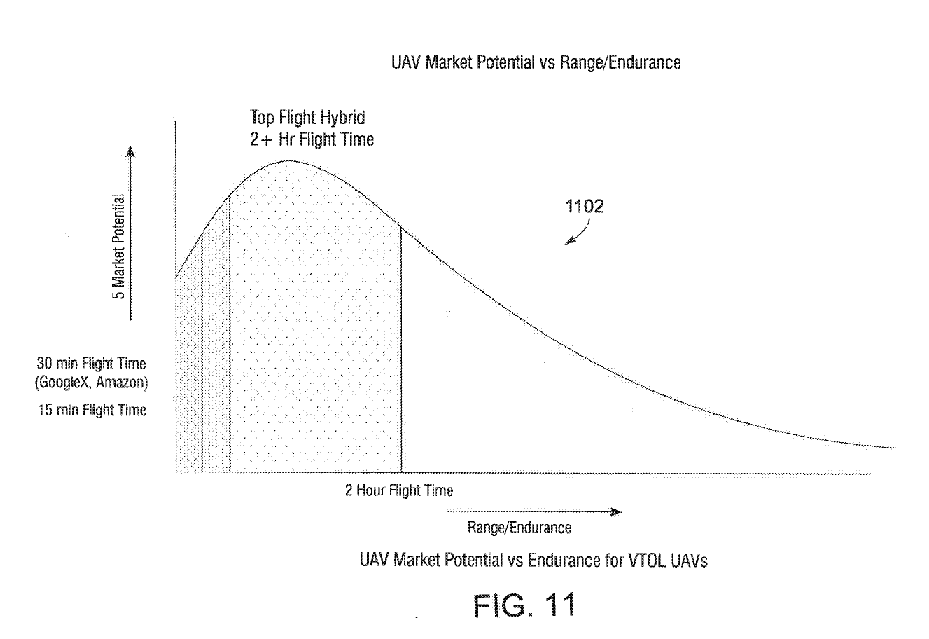

FIG. 11 shows a graph 1104 of market potential for UAVs against flight time for an example two plus hours of flight time micro hybrid generator system 500 when coupled to a UAV is able to achieve and an example of the total market potential vs. endurance for the micro hybrid generator system 500 for UAVs.

In some examples, the micro hybrid generator power systems 500 can be integrated as part of a UAV or similar type aerial robotic vehicle to perform as a portable flying generator using the primary source of power to sustain flight of the UAV and then act as a primary power source of power when the UAV has reached its destination and is not in flight. For example, when a UAV which incorporates the micro hybrid generator power system 500 (e.g., the UAV 900 of FIG. 9) is not in flight, the available power generated by micro hybrid system can be transferred to one or more of external loads 518, 526, 528, and/or 536 such that micro hybrid generator system 500 operates as a portable generator. Micro hybrid system generator 500 can provide continuous peak power generation capability to provide power at remote and often difficult to reach locations. In the “non-flight portable generator mode,” micro hybrid system 500 can divert the available power generation capability towards external one or more of loads 518, 526, 528, and/or 536. Depending on the power requirements, one or more of DC-to-AC inverters 522, 532 may be used to convert DC voltage to standard AC power (120 VAC or 240 VAC).

In some examples, micro hybrid generator system 500 coupled to a UAV (e.g., UAV 900 of FIG. 9) will be able to traverse from location to location using aerial flight, land, and switch on the power generator to convert fuel into power.

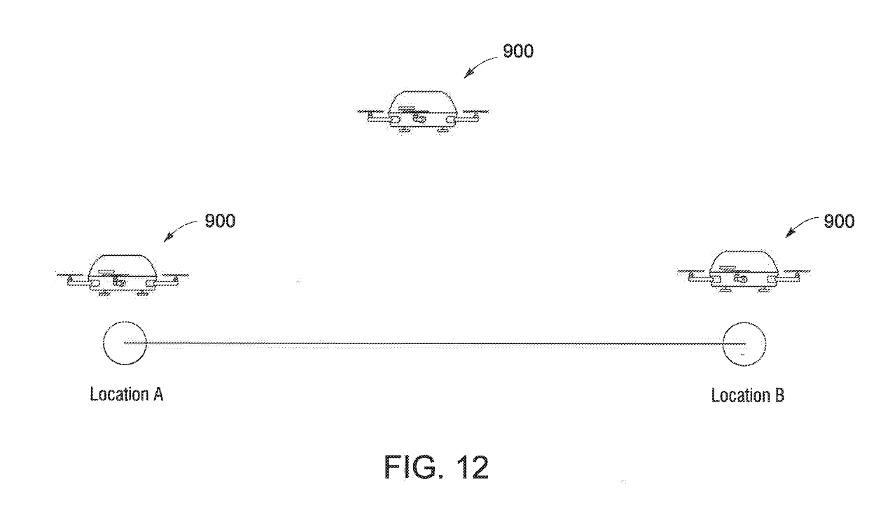

FIG. 12 shows an example flight pattern of a UAV with a micro hybrid generator system 500. In the example flight pattern shown in FIG. 12, the UAV 900, with micro hybrid system 500 coupled thereto, begins at location A loaded with fuel ready to fly. The UAV 900 then travels from location A to location B and lands at location B. The UAV 900 then uses micro hybrid system 500 to generate power for local use at location B, thereby acting as a portable flying generator. When power is no longer needed, the UAV 900 returns back to location A and awaits instructions for the next task.

In some examples, the UAV 900 uses the power provided by micro hybrid generator system 500 to travel from an initial location to a remote location, fly, land, and then generate power at the remote location. Upon completion of the task, the UAV 900 is ready to accept commands for its new task. All of this can be performed manually or through an autonomous/automated process. In some examples, the UAV 900 with micro hybrid generator system 500 can be used in an applicable application where carrying fuel and a local power generator are needed. Thus, the UAV 900 with a micro hybrid generator system 500 eliminates the need to carry both fuel and a generator to a remote location. The UAV 900 with a micro hybrid generator system 500 is capable of powering both the vehicle when in flight, and when not in flight can provide the same amount of available power to external loads. This may be useful in situations where power is needed for the armed forces in the field, in humanitarian or disaster relief situations where transportation of a generator and fuel is challenging, or in situations where there is a request for power that is no longer available, to name a few.

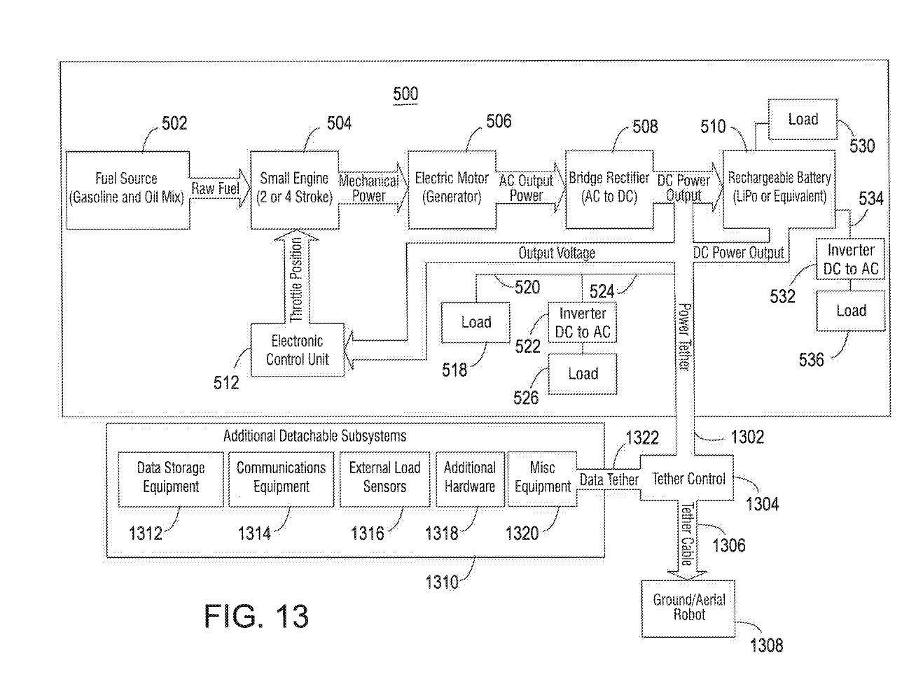

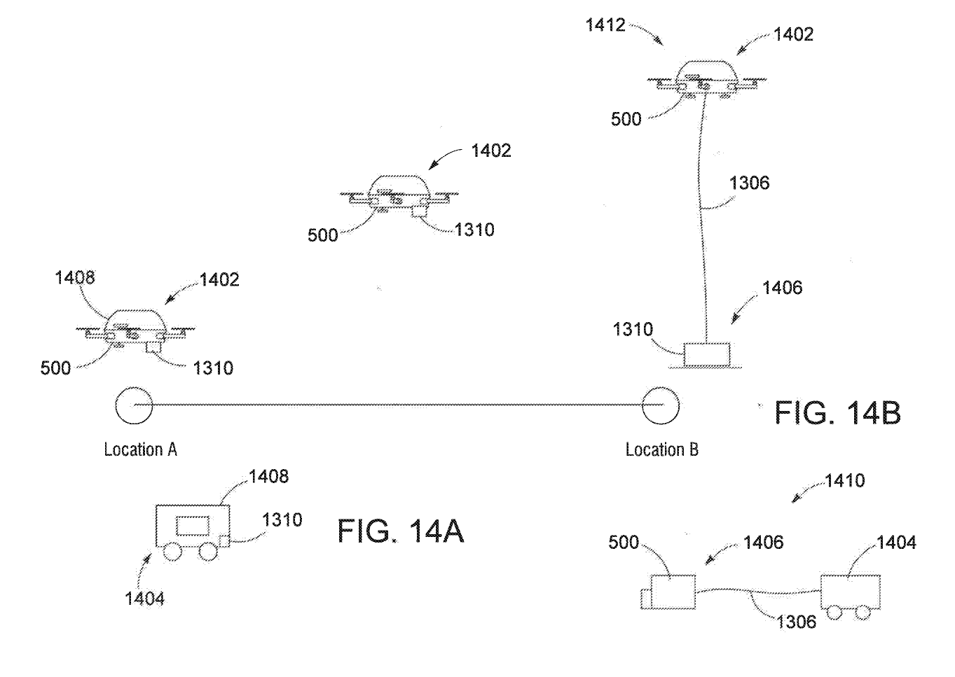

FIG. 13 shows a diagram of another system for a micro hybrid generator system 500 with detachable subsystems. FIG. 14A shows a diagram of a micro hybrid generator system 500 with detachable subsystems integrated as part of a UAV. FIG. 14B shows a diagram of a micro hybrid generator system 500 with detachable subsystems integrated as part of a ground robot. In some examples, a tether line 1302 is coupled to the DC output of bride rectifier 508 and rechargeable battery 510 of a micro hybrid control system 500. The tether line 1302 can provide DC power output to a tether controller 1304. The tether controller 1304 is coupled between a tether cable 1306 and a ground or aerial robot 1308. In operation, as discussed in further detail below, the micro hybrid generator system 500 provides tethered power to the ground or aerial robot 1308 with the similar output capabilities as discussed above with one or more of the figures included herein.

The system shown in FIG. 13 can include additional detachable components 1310 integrated as part of the system. For example, the system can include data storage equipment 1312, communications equipment 1314, external load sensors 1316, additional hardware 1318, and various miscellaneous equipment 1320 that can be coupled via data tether 1322 to tether controller 1304.

In some examples of operation of the system shown in FIG. 13, the system may be configured as part of a flying robot or UAV, such as flying robot or UAV (1402 of FIG. 14), or as ground robot 1404. Portable tethered robotic system 1408 may start a mission at location A. All or an applicable combination of the subsystems and ground, the tether controller, ground/aerial robot 1308 can be powered by the micro hybrid generator system 500. The Portable tethered robotic system 1408 can travel either by ground (e.g., using ground robot 1404 powered by micro hybrid generator system 500) or by air (e.g., using flying robot or UAV 1402 powered by micro hybrid generator system 500) to desired remote location B. At location B, portable tethered robotic system 1408 configured as flying robot 1402 or ground robot 1404 can autonomously decouple micro hybrid generator system 500 and/or detachable subsystem 1310, indicated at 1406, which remain detached while ground robot 1404 or flying robot or UAV 1402 are operational. When flying robot or UAV 1402 is needed at location B, indicated at 1412, flying robot or UAV 1402 can be operated using power provided by micro hybrid generator system coupled to tether cable 1306. When flying robot or UAV 1402 no longer has micro hybrid generator system 500 and/or additional components 1310 attached thereto, it is significantly lighter and can be in flight for a longer period of time. In some examples, flying robot or UAV 1402 can take off and remain in a hovering position remotely for extended periods of time using the power provided by micro hybrid generator system 500.

Similarly, when ground robot 1404 is needed at location B, indicated at 1410, it may be powered by micro hybrid generator system 500 coupled to tether line 1306 and may also be significantly lighter without micro hybrid generator system 500 and/or additional components 1310 attached thereto. Ground robot 1404 can also be used for extended periods of time using the power provide by micro hybrid generator system 500.

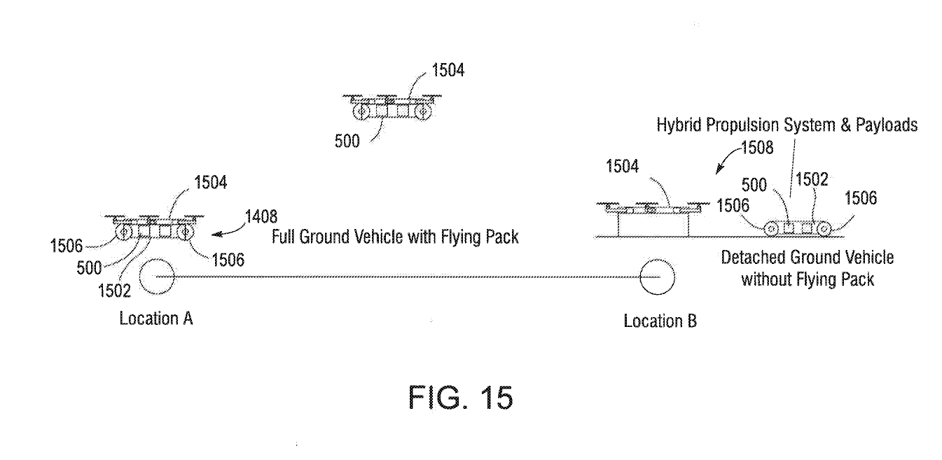

FIG. 15 shows a ground robot 1502 with a detachable flying pack 1504 in operation. The detachable flying pack 1504 includes micro hybrid generator system 500. The detachable flying pack 1504 is coupled to the ground robot 1502 of one or more embodiments. The micro hybrid generator system 500 is embedded within the ground robot 1502. The ground robot 1502 is detachable from the flying pack 1504. With such a design, a majority of the capability may be embedded deep within the ground robot 1502 which can operate 100% independently of the flying pack 1504. When the ground robot 1502 is attached to the flying pack 1504, the flying pack 1504 may be powered from micro hybrid generator system 500 embedded in the ground robot 1502 and the flying pack 1504 provides flight. The ground robot 1502 platform can be a leg wheel or threaded base motion.

In some examples, the ground robot 1502 may include the detachable flying pack 1504 and the micro hybrid generator system 500 coupled thereto as shown in FIG. 15. In the illustrated example, the ground robot 1502 is a wheel-based robot as shown by wheels 1506. In this example, the micro hybrid generator system 500 includes fuel source 502, small engine 504, generator motor 506, bridge rectifier 508, rechargeable battery 20, ECU 512, and optional inverters 522 and 532, as discussed above with reference to one or more figures included herein. The micro hybrid generator system 500 also preferably includes data storage equipment 1312, communications equipment 1314, external load sensors 1316, additional hardware 1318, and miscellaneous communications 1320 coupled to data line 1322 as shown. The flying pack 1504 is preferably an aerial robotic platform such as a fixed wing, single rotor or multi rotor, aerial device, or similar type aerial device.

In some examples, the ground robot 1502 and the aerial flying pack 1504 are configured as a single unit. Power is delivered from micro hybrid generator system 500 and is used to provide power to flying pack 1504, so that ground robot 1502 and flying pack 1504 can fly from location A to location B. At location B, ground robot 1506 detaches from flying pack 1504, indicated at 1508, and is able to maneuver and operate independently from flying pack 1504. Micro hybrid generator system 500 is embedded in ground robot 1502 such that ground robot 1506 is able to be independently powered from flying pack 1504. Upon completion of the ground mission, ground robot 1502 is able to reattached itself to flying pack 1504 and return to location A. All of the above operations can be manual, semi-autonomous, or fully autonomous.

In some examples, flying pack 1504 can traverse to a remote location and deliver ground robot 1502. At the desired location, there may be no need for flying pack 1504. As such, it can be left behind so that ground robot 1502 can complete its mission without having to carry flying pack 1504 as its payload. This may be useful for traversing difficult and challenging terrains, remote locations, and in situations where it is challenging to transport ground robot 1502 to the location. Exemplary applications may include remote mine destinations, remote surveillance and reconnaissance, and package delivery services where flying pack 1504 cannot land near an intended destination. In these examples, a designated safe drop zone for flying pack can be used and local delivery is completed by ground robot 1502 to the destination.

In some examples, upon a mission being completed, ground robot 1404 or flying robot or UAV 1402 can be autonomously coupled back to micro hybrid generator system 500. In some implementations, such coupling is performed automatically upon the mission being completed. Additional detachable components 1310 can be autonomously coupled back micro hybrid generator system 500. Portable tethered robotic system 1408 with a micro hybrid generator system 500 configured a flying robot or UAV 1402 or ground robot 1404 then returns to location A using the power provided by micro hybrid generator system 500.

The result is portable tethered robotic system 1408 with a micro hybrid generator system 500 is able to efficiently transport ground robot 1404 or flying robot or UAV 1402 to remote locations, automatically decouple ground robot 1404 or flying robot or UAV 1402, and effectively operate the flying robot 1402 or ground robot 1404 using tether power where it may be beneficial to maximize the operation time of the ground robot 1402 or flying robot or UAV 1404. System 1408 provides modular detachable tethering which may be effective in reducing the weight of the tethered ground or aerial robot, thereby reducing its power requirements significantly. This allows the aerial robot or UAV or ground robot to operate for significantly longer periods of time when compared to the original capability where the vehicle components are attached and the vehicle needs to sustain motion. System 1408 eliminates the need to assemble a generator, robot and tether at remote locations and therefore saves time, resources, and expense. Useful applications of system 1408 may include, inter alia, remote sensing, offensive or defensive military applications and/or communications networking, multi-vehicle cooperative environments, and the like.

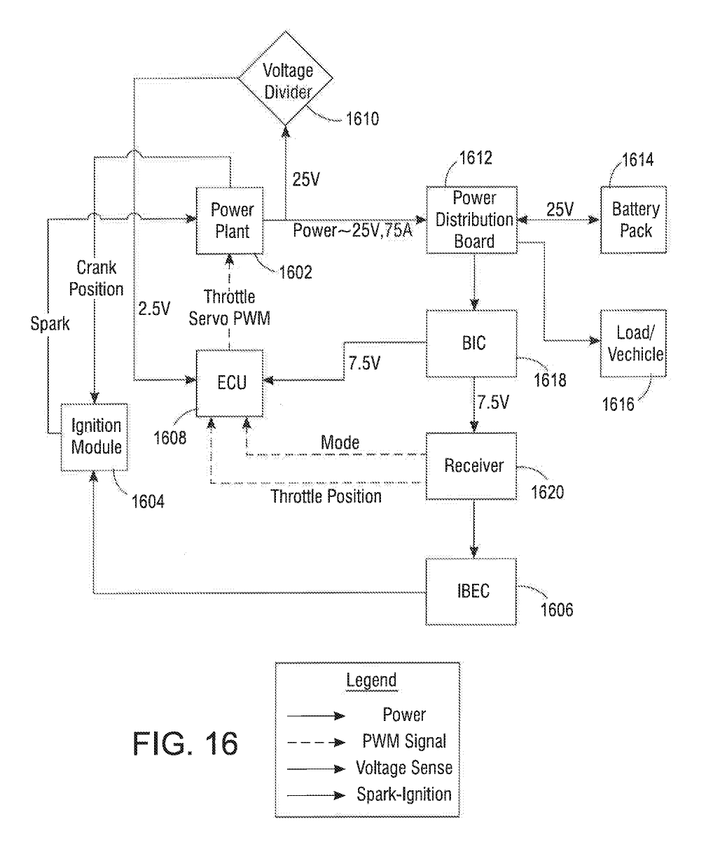

FIG. 16 shows a control system of a micro hybrid generator system. The micro hybrid generator system includes a power plant 1602 coupled to an ignition module 1604. The ignition module 1604 functions to start the power plant 1602 by providing a physical spark to the power plant 1604. The ignition module 1604 is coupled to an ignition battery eliminator circuit (IBEC) 1606. The IBEC 1606 functions to power the ignition module 1604.

The power plant 1602 is configured to provide power. The power plant 1602 includes a small engine and a generator. The power plant is controlled by the ECU 1608. The ECU 1608 is coupled to the power plant through a throttle servo. The ECU 1608 can operate the throttle servo to control a throttle of a small engine to cause the power plant 1602 to either increase or decrease an amount of produced power. The ECU 1608 is coupled to a voltage divider 1610. Through the voltage divider 1610, the ECU can determine an amount of power the ECU 1608 is generating to determine whether to increase, decrease, or keep a throttle of a small engine constant.

The power plant is coupled to a power distribution board 1612. The power distribution board 1612 can distribute power generated by the power plant 1602 to either or both a battery pack 1614 and a load/vehicle 1616. The power distribution board 1612 is coupled to a battery eliminator circuit (BEC) 1618. The BEC 1618 provides power to the ECU 1608 and a receiver 1620. The receiver 1620 controls the IBEC 1606 and functions to cause the IBEC 1606 to power the ignition module 1604. The receiver 1620 also sends information to the ECU 1608 used in controlling a throttle of a small engine of the power plant 1602. The receiver 1620 sends information to the ECU related to a throttle position of a throttle of a small engine and a mode in which the micro hybrid generation system is operating.

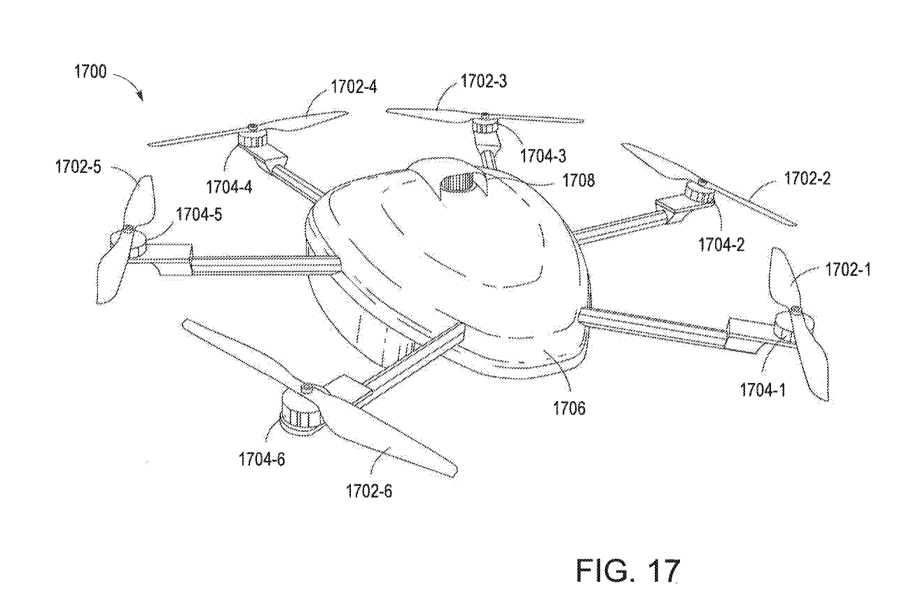

FIG. 17 shows a top perspective view of a top portion 1700 of a drone powered through a micro hybrid generator system. The top portion 1700 of the drone shown in FIG. 13 includes six rotors 1702-1 through 1702-6 (hereinafter “rotors 1702”). The rotors 1702 are caused to spin by corresponding motors 1704-1 through 1704-6 (hereinafter “motors 1704”). The motors 1704 can be powered through a micro hybrid generator system. The top portion 1700 of a drone includes a top surface 1706. Edges of the top surface 1706 can be curved to reduce air drag and improve aerodynamic performance of the drone. The top surface includes an opening 1708 through which air can flow to aid in dissipating heat away from at least a portion of a micro hybrid generator system. In various embodiments, at least a portion of an air filter is exposed through the opening 1708.

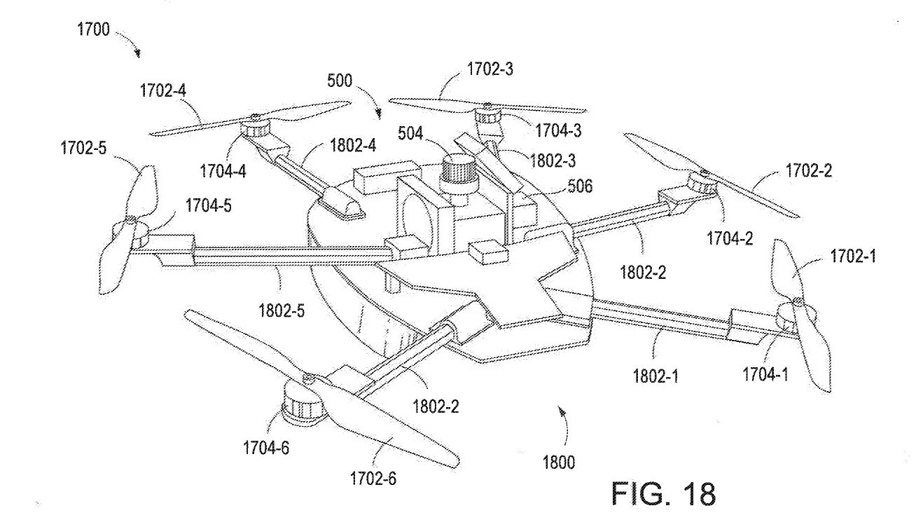

FIG. 18 shows a top perspective view of a bottom portion 1800 of a drone powered through a micro hybrid generator system 500. The micro hybrid generator system 500 includes a small engine 504 and a generator motor 506 to provide power to motors 1704. The rotor motors 1704 and corresponding rotors 1702 are positioned away from a main body of a bottom portion 1800 of the drone through arms 1802-1 through 1802-6 (hereinafter “arms 1802”). An outer surface of the bottom portion of the bottom portion 1800 of the drone and/or the arms 1802 can have edges that are curved to reduce air drag and improve aerodynamic performance of the drone.

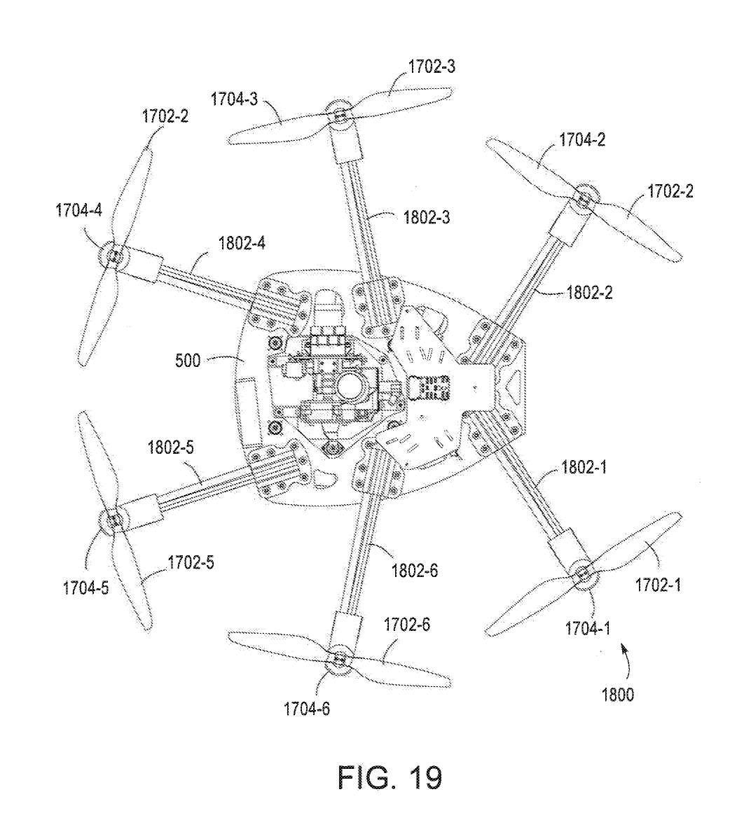

FIG. 19 shows a top view of a bottom portion 1800 of a drone powered through a micro hybrid generator system 500. The rotor motors 1704 and corresponding rotors 1702 are positioned away from a main body of a bottom portion 1800 of the drone through arms 1802. An outer surface of the bottom portion of the bottom portion 1800 of the drone and/or the arms 1802 can have edges that are curved to reduce air drag and improve aerodynamic performance of the drone.

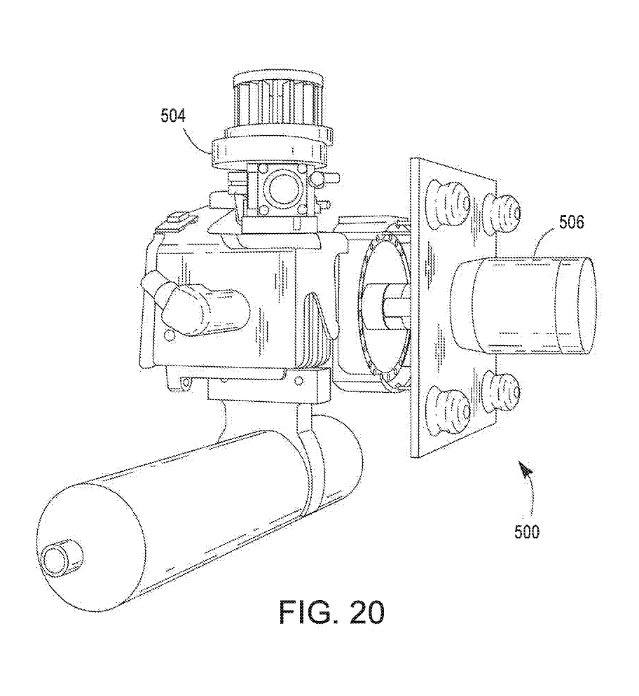

FIG. 20 shows a side perspective view of a micro hybrid generator system 500. The micro hybrid generator system 500 shown in FIG. 16 is capable of providing 1.8 kW of power. The micro hybrid generator system 500 include a small engine 504 coupled to a generator motor 506. The small engine 504 can provide approximately 3 horsepower. The generator motor 506 functions to generate AC output power using mechanical power generated by the small engine 504.

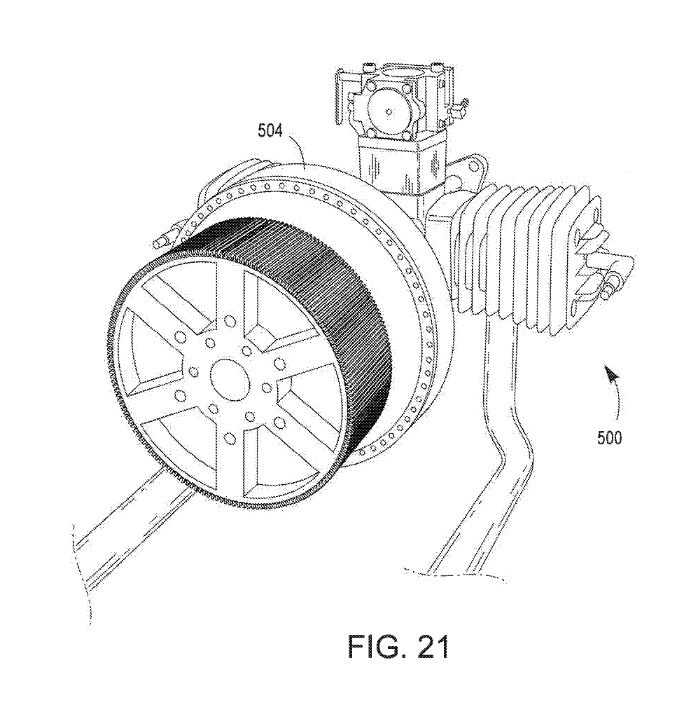

FIG. 21 shows a side perspective view of a micro hybrid generator system 500. The micro hybrid generator system 500 shown in FIG. 17 is capable of providing 10 kW of power. The micro hybrid generator system 500 include a small engine 504 coupled to a generator motor. The small engine 504 can provide approximately 15-16.5 horsepower. The generator motor functions to generate AC output power using mechanical power generated by the small engine 504.

Further description of UAVs and micro hybrid generator systems can be found in U.S. application Ser. No. 14/942,600, filed on Nov. 16, 2015, the contents of which are incorporated here by reference in their entirety.

In some examples, the small engine 504 can include features that enable the engine to operate with high power density. The small engine 504 can be a two-stroke engine having a high power-to-weight ratio. The small engine 504 can embody a simply design with a small number of moving parts such that the engine is small and light, thus contributing to the high power-to-weight ratio of the engine. In some examples, the small engine may have an energy density of 1 kW/kg (kilowatt per kilogram) and generate about 10 kg of lift for every kilowatt of power generated by the small engine. In some examples, the small engine 504 can be a brushless motor, which can contribute to achieving a high power density of the engine. A brushless motor is efficient and reliable, and is generally not prone to sparking, thus reducing the risk of electromagnetic interference (EMI) from the engine.

In some examples, the small engine 504 is mounted on the UAV via a vibration isolation system that enables sensitive components of the UAV to be isolated from vibrations generated by the engine. Sensitive components of the UAV can include, e.g., an inertial measurement unit such as Pixhawk, a compass, a global positioning system (GPS), or other components.

In some examples, the vibration isolation system can include vibration damping mounts that attach the small engine to the frame of the UAV. The vibration damping mounts allow for the engine 504 to oscillate independently from the frame of the UAV, thus preventing vibrations from being transmitted from the engine to other components of the UAV. The vibration damping mounts can be formed from a robust, energy absorbing material such as rubber, that can absorb the mechanical energy generated by the motion of the engine without tearing or ripping, thus preventing the mechanical energy from being transferred to the rest of the UAV. In some examples, the vibration damping mounts can be formed of two layers of rubber dampers joined together rigidly with a spacer. The length of the spacer can be adjusted to achieve a desired stiffness for the mount. The hardness of the rubber can be adjusted to achieve desired damping characteristics in order to absorb vibrational energy.

Referring to FIG. 22A, in some examples, the small engine 504 and the generator motor 506 are directly coupled through a precise and robust connection (e.g., through a urethane coupling 704). In particular, the generator motor 506 includes a generator rotor 706 and a generator stator 708 housed in a generator body 2202. The generator rotor 706 is attached to the generator body 2202 by generator bearings 2204. The generator rotor 706 is coupled to an engine shaft 606 via the coupling 704. Precision coupling between the small engine 504 and the generator motor 506 can be achieved by using precisely machined parts and balancing the weight and support of the rotating components of the generator motor 506, which in turn reduces internal stresses. Alignment of the generator rotor 706 with the engine shaft 606 can also help to achieve precision coupling. Misalignment between the rotor 706 and the engine shaft 606 can cause imbalances that can reduce efficiency and potentially lead to premature failure. In some examples, alignment of the rotor 706 with the engine shaft 606 can be achieved using precise indicators and fixtures. Precision coupling can be maintained by cooling the small engine 504 and generator motor 506, by reducing external stresses, and by running the small engine 504 and generator motor 506 under steady conditions, to the extent possible. For instance, the vibration isolation mounts allow external stresses on the small engine 504 to be reduced or substantially eliminated, assisting in achieving precision direct coupling.

Direct coupling can contribute to the reliability of the first power system, which in turn enables the micro hybrid generator system to operate continuously for long periods of time at high power. In addition, direct coupling can contribute to the durability of the first power system, thus helping to reduce mechanical creep and fatigue even over many engine cycles (e.g., millions of engine cycles). In some examples, the engine is mechanically isolated from the frame of the UAV by the vibration isolation system and thus experiences minimal external forces, so the direct coupling between the engine and the generator motor can be implemented by taking into account only internal stresses.

Direct coupling between the small engine 504 and the generator motor 506 can enable the first power system to be a compact, lightweight power system having a small form factor. A compact and lightweight power system can be readily integrated into the UAV.

Referring to FIG. 22B, in some examples, a frameless or bearing-less generator 608 can be used instead of a urethane coupling between the generator motor 506 and the small engine 504. For instance, the bearings (2204 in FIG. 22A) on the generator can be removed and the generator rotor 706 can be directly mated to the engine shaft 606. The generator stator 708 can be fixed to a frame 610 of the engine 516. This configuration prevents over-constraining the generator with a coupling while providing a small form factor and reduced weight and complexity.

In some examples, the generator motor 506 includes a flywheel that provides a large rotational moment of inertia. A large rotational inertia can result in reduced torque spikes and smooth power output, thus reducing wear on the coupling between the small engine 504 and the generator motor 506 and contributing to the reliability of the first power system. In some examples, the generator, when mated directly to the small engine 504, acts as a flywheel. In some examples, the flywheel is a distinct component (e.g., if the generator does not provide enough rotary inertia).

In some examples, design criteria are set to provide good pairing between the small engine 504 and the generator motor 506. The power band of a motor is typically limited to a small range. This power band can be used to identify an RPM (revolutions per minute) range within which to operate under most flight conditions. Based on the identified RPM range, a generator can be selected that has a motor constant (kV) that is able to provide the appropriate voltage for the propulsion system (e.g., the rotors). The selection of an appropriate generator helps to ensure that the voltage out of the generator will not drop as the load increases. For instance, if the engine has maximum power at 6500 RPM, and a 50 V system is desired for propulsion, then a generator can be selected that has a kV of 130.

In some examples, exhaust pipes can be designed to positively affect the efficiency of the small engine 504. Exhaust pipes serve as an expansion chamber for exhaust from the engine, thus improving the volumetric efficiency of the engine. The shape of the exhaust pipes can be tuned to guide air back into the combustion chamber based on the resonance of the system. In some examples, the carburetor can also be tuned based on operating parameters of the engine, such as temperature or other parameters. For instance, the carburetor can be tuned to allow a desired amount of fuel into the engine, thus enabling a target fuel to air ratio to be reached in order to achieve a good combustion reaction in the engine. In addition, the throttle body can be designed to control fuel injection and/or timing in order to further improve engine output.

In some examples, the throttle of the engine can be regulated in order to achieve a desired engine performance. For instance, when the voltage of the system drops under a load, the throttle is increased; when the voltage of the system becomes too high, the throttle is decreased. The bus voltage can be regulated and a feedback control loop used to control the throttle position. In some examples, the current flow into the battery can be monitored with the goal of controlling the charge of the battery and the propulsion voltage. In some examples, feed forward controls can be provided such that the engine can anticipate upcoming changes in load (e.g., based on a mission plan and/or based on the load drawn by the motor) and preemptively compensates for the anticipated changes. Feed forward controls can enable the engine to respond to changes in load with less lag. In some examples, the engine can be controlled to charge the battery according to a pre-specified schedule, e.g., to maximize battery life, in anticipation of loads (e.g., loads forecast in a mission plan), or another goal. Throttle regulation can help keep the battery fully charged, helping to ensure that the system can run at a desired voltage and helping to ensure that backup power is available.

In some examples, ultra-capacitors can be incorporated into the micro hybrid generator system in order to allow the micro hybrid generator system to respond quickly to changing power demands. For instance, ultra-capacitors can be used in conjunction with one or more rechargeable batteries to provide a lightweight system capable of rapid response and smooth, reliable power.

In some examples, thermal management strategies can be employed in order to actively or passively cool components of the micro hybrid generator system. High power density components tend to overheat (e.g., because thermal dissipation is usually proportional to surface area). In addition, internal combustion is an inherently inefficient process, which creates heat.

Active cooling strategies can include fans, such as a centrifugal fan. The centrifugal fan can be coupled to the engine shaft so that the fan spins at the same RPM as the engine, thus producing significant air flow. The centrifugal fan can be positioned such that the air flow is directed over certain components of the engine (e.g., the hottest parts of the engine) such as the cylinder heads. Air flow generated by the flying motion of the UAV can also be used to cool the micro hybrid generator system. For instance, air pushed by the rotors of the UAV (referred to as propwash) can be used to cool components of the micro hybrid generator system. Passive cooling strategies can be used alone or in combination with active cooling strategies in order to cool components of the micro hybrid generator system. In some examples, one or more components of the micro hybrid generator system can be positioned in contact with dissipative heat sinks, thus reducing the operating temperature of the components. For instance, the frame of the UAV can be formed of a thermally conductive material, such as aluminum, which can act as a heat sink. Referring to FIG. 22, in some examples, fins 2302 can be formed on the engine (e.g., on one or more of the cylinder heads of the engine) to increase the convective surface area of the engine, thus enabling increased heat transfer. In some examples, the micro hybrid generator system can be configured such that certain components are selectively exposed to ambient air or to air flow generated by the flying motion of the UAV in order to further cool the components.

In some examples, the materials of the micro hybrid generator system 500 and/or the UAV can be lightweight. For instance, materials with a high strength to weight ratio can be used to reduce weight. Example materials can include aluminum or high strength aluminum alloys (e.g., 7075 alloy), carbon fiber based materials, or other materials. Component design can also contribute to weight reduction. For instance, components can be designed to increase the stiffness and reduce the amount of material used for the components. In some examples, components can be designed such that material that is not relevant for the functioning of the component is removed, thus further reducing the weight of the component.

While the UAV has been largely described as being powered by a micro hybrid generator system that includes a gasoline powered engine coupled to a generator motor, other types of power systems may also be used. In some implementations, the UAV may be powered at least in part by a turbine, such as a gasoline turbine. For example, a gasoline turbine can be used in place of the gasoline powered engine. The gasoline turbine may be one of two separate power systems included as part of the micro hybrid generator system. That is, the micro hybrid generator system can include a first power system in the form of a gasoline turbine and a second power system in the form of a generator motor. The gasoline turbine may be coupled to the generator motor.

The gasoline turbine may provide higher RPM levels than those provided by a gasoline powered engine (e.g., the small engine 504 described above). Such higher RPM capability may allow a second power system (e.g., the generator motor 506 described above) to generate electricity (e.g., for charging the battery 510 described above) more quickly and efficiently.

The gasoline turbine, sometimes referred to as a combustion turbine, may include an upstream rotation compressor coupled to a downstream turbine with a combustion chamber therebetween. The gasoline turbine may be configured to allow atmospheric air to flow through the compressor, thereby increasing the pressure of the air. Energy may then be added by applying (e.g., spraying) fuel, such as gasoline, into the air and igniting the fuel in order to generate a high-temperature flow. The high-temperature and high-pressure gas flow may then enter the turbine, where the gas flow can expand down to the exhaust pressure, thereby producing a shaft work output. The turbine shaft work is then used to drive the compressor and other devices, such as a generator (e.g., the generator motor 504) that may be coupled to the shaft. Energy that is not used for shaft work can be expelled as exhaust gases having one or both of a high temperature and a high velocity. One or more properties and/or dimensions of the gas turbine design can be chosen such that the most desirable energy form is maximized. In the case of use with a UAV, the gas turbine will typically be optimized to produce thrust from the exhaust gas or from ducted fans connected to the gas turbines.

A number of embodiments have been described. Nevertheless, it will be understood that various modifications may be made without departing from the spirit and scope of the subject matter described herein. Other such embodiments are within the scope of the following claims.

What is claimed is:

1. An unmanned aerial vehicle comprising:
an atmospheric sensor configured to measure an atmospheric condition;
a rotor motor configured to drive rotation of a propeller of the unmanned aerial vehicle; and
a hybrid energy generation system comprising:
a rechargeable battery configured to provide electrical energy to the rotor motor;
an engine configured to generate mechanical energy; and
a generator coupled to the engine and configured to generate electrical energy from the mechanical energy generated by the engine, the electrical energy generated by the generator being provided to at least one of the rechargeable battery and the rotor motor.

2. The unmanned aerial vehicle of claim 1, wherein the atmospheric sensor comprises one or more of a thermometer, a barometer, a humidity sensor, a wind sensor, and a solar radiation sensor.

3. The unmanned aerial vehicle of claim 1, wherein the atmospheric sensor comprises a sensor configured to measure an impurity in one or more of precipitation and ambient moisture.

4. The unmanned aerial vehicle of claim 1, wherein the atmospheric sensor comprises a sensor configured to measure particulates in air.

5. The unmanned aerial vehicle of claim 1, wherein the atmospheric sensor comprises a sensor configured to measure an air quality.

6. The unmanned aerial vehicle of claim 1, comprising an avionics system configured to control navigation of the unmanned aerial vehicle.

7. The unmanned aerial vehicle of claim 6, wherein the avionics system is configured to control one or more of a lateral motion of the unmanned aerial vehicle and an altitude of the unmanned aerial vehicle.

8. The unmanned aerial vehicle of claim 6, wherein the avionics system is configured to control the navigation of the unmanned aerial vehicle based on the atmospheric condition measured by the atmospheric sensor.

9. The unmanned aerial vehicle of claim 8, wherein the avionics system is configured to control the navigation of the unmanned aerial vehicle based on the measured atmospheric condition satisfying a target atmospheric condition.

10. The unmanned aerial vehicle of claim 1, comprising a processor configured to determine a second atmospheric condition based on a measured inertial output of the unmanned aerial vehicle.

11. The unmanned aerial vehicle of claim 10, comprising an inertial measurement unit configured to measure the inertial output of the unmanned aerial vehicle.

12. The unmanned aerial vehicle of claim 1, comprising a flexible coupling device directly coupling a rotor of the engine to the generator.

13. The unmanned aerial vehicle of claim 12, wherein the coupling device includes a cooling device oriented to provide air flow to one or more of the engine and the generator.

14. A method comprising:
operating a hybrid energy generation system to provide electrical energy to a rotor motor configured to drive rotation of a propeller of an unmanned aerial vehicle, including:
generating mechanical energy in an engine of the hybrid energy generation system,
in a generator of the hybrid energy generation system, converting the mechanical energy into electrical energy,
providing at least some of the electrical energy produced by the generator to a rechargeable battery of the hybrid energy generation system, and
providing electrical energy to the rotor motor, the electrical energy being one or more of (i) the electrical energy produced by the generator and (ii) electrical energy from the rechargeable battery; and
measuring an atmospheric condition by an atmospheric sensor disposed on the unmanned aerial vehicle.

15. The method of claim 14, comprising controlling a navigation of the unmanned aerial vehicle

16. The method of claim 15, comprising controlling the navigation of the unmanned aerial vehicle responsive to the measured atmospheric condition.

17. The method of claim 16, comprising controlling one or more of an altitude, a lateral motion, and a rotation of the unmanned aerial vehicle responsive to the measured atmospheric condition.

18. The method of claim 16, comprising controlling the navigation of the unmanned aerial vehicle based on the measured atmospheric condition satisfying a target atmospheric condition.

19. The method of claim 16, comprising controlling the navigation of the unmanned aerial vehicle based on an expected atmospheric condition.

20. The method of claim 14, comprising:
measuring an inertial output of the unmanned aerial vehicle; and
determining a second atmospheric condition based on the measured inertial output.

21. The method of claim 20, comprising measuring the inertial output of the unmanned aerial vehicle.

22. The method of claim 14, wherein measuring an atmospheric condition comprises measuring one or more of a temperature, a pressure, a humidity, a wind characteristic, and a solar radiation characteristic.

23. The method of claim 14, wherein measuring an atmospheric condition comprises measuring an impurity in one or more of precipitation and ambient moisture.

24. The method of claim 14, wherein measuring an atmospheric condition comprises measuring particulates in air.

25. The method of claim 14, wherein measuring an atmospheric condition comprises measuring an air quality.
